(19) United States
(12) Patent Application Publication
(10) Pub. No.: US 2004/0144142 A1
(43) Pub. Date: Jul. 29, 2004

(54) Modular vehicle door lock and latch system and method

(75) Inventors: Steven J. Dimig, Plymouth, WI (US); John K. Feuerstein, Racine, WI (US)

Correspondence Address: MICHAEL BEST & FRIEDRICH, LLP, 100 E WISCONSIN AVENUE, MILWAUKEE, WI, 53202, US

(73) Assignee: STRATTEC SECURITY CORPORATION, Milwaukee, WI

(21) Appl. No.: 10/757,053

(22) Filed: Jan. 14, 2004

Related U.S. Application Data
(63) Continuation-in-part of application No. 10/352,794, filed on Jan. 28, 2003.
Application No. 10/352,794 is a continuation of application No. 09/442,724, filed on Nov. 18, 1999, now Pat. No. 6,530,251.

(51) Int. Cl. E05B 13/00

(52) U.S. Cl. 70/208; 70/237

(57) ABSTRACT

A locking and latching system is disclosed in which some of the components of the system can be pre-assembled prior to installation into the structural framework of a vehicle door. The construction of the lock and latch system of the present invention can include outside and inside door handles, outside and inside locks, the door latch itself, as well as linkages between these components. The components of the present invention can further facilitate the assembly process by being of a design which simplifies the process of installing them into the structural framework of a vehicle door without requiring the use of specialized tools, thereby reducing labor costs associated with assembly.

### CROSS-REFERENCE TO RELATED APPLICATIONS

This is a continuation-in-part of U.S. application Ser. No. 10/352,794, filed Jan. 28, 2003, which is a continuation of U.S. application Ser. No. 09/442,724, filed Nov. 18, 1999. The entire contents of application Ser. No. 10/352,794 is hereby incorporated by reference.

### BACKGROUND OF THE INVENTION

The present invention relates generally to a vehicle door locking and latching apparatus, and more particularly to an improved modular vehicle door lock and latch system. Locking and latching systems typically have one or more limitations relating to installation difficulty, speed, and/or cost. In light of these and other limitations of conventional locking and latching systems, new locking and latching systems would be welcome in the art.

### SUMMARY OF THE INVENTION

Some embodiments of the present invention provide a locking and latching system of modular construction such that at least two of the components of the system are pre-assembled prior to their installation into the structural framework of a vehicle door. In some embodiments, the lock and latch system includes modular components including various user-manipulatable controls (e.g., outside and inside door handles and outside and inside locks), the door latch itself, as well as all linkages between these components. Modular components can facilitate the assembly process by simplifying the process of installing them into the structural framework of a vehicle door, and by not requiring the use of specialized tools, thereby further reducing the labor costs associated with assembly. In some cases, the present invention can substantially enhance the security of a vehicle by providing a lock and latch system which has an enhanced level of resistance to manipulation by jimmying with a “slim jim” or similar tool of the type commonly used by car thieves.

In some embodiments of the present invention, a lock and latch system is manufactured in three modular assemblies, the first of which includes an inside door handle, an inside lock, a door latch, and an outside door lock and door handle interface member, as well as linkages between these components. The second component in such embodiments can be an outside door lock which is easily installed in the outside door lock and door handle interface member. The third component in such embodiments can be an outside door handle assembly which will be operatively connected to the outside door lock and door handle interface member.

In some alternate embodiments, the inside door handle and the inside lock together comprise a fourth component which is not necessarily initially connected to the rest of the first component (the door latch, the outside door lock and door handle interface member, and the linkages between components). In such embodiments, the first component can, however, include the linkage members which will be connected to the mechanism of the inside door handle of the inside door lock. While the rest of the first component is installed in the structural framework of the vehicle door, these linkage members can extend out of the vehicle door to allow them to be connected to the inside door handle in the inside door lock. Thus, in such embodiments, following the connection of the first and fourth components together, the inside door handle in the inside door lock can be installed into the structural framework of the vehicle door.

The outside door handle according to some embodiments can be installed in the manner described in U.S. Pat. No. 5,706,554, to Rükert et al. (i.e., by placing the outside door handle assembly into position in an opening in the outer skin of the structural framework of the vehicle door and moving the handle from its non-actuated position to its actuated position). U.S. Pat. No. 5,706,554 is hereby incorporated herein by reference insofar as it relates to the connection of door handle assemblies to doors via actuation of door handles. Alternately, a conventional design door handle (e.g., a paddle type or a pull strap type) can be used instead of the type of door handle taught by the '554 patent. Either of these types of door handles can be mounted and pivot with respect to any desired structure, such as an outside door handle housing member (which can, for example, be part of the second component described above), a portion of the vehicle door (e.g., the sheet metal of the outer skin and/or the structural framework of the vehicle door), or an outside door lock and door handle interface member.

When employed, the outside door lock and door handle interface member can be installed in or adjacent to the opening in the outer skin of the structural framework of a vehicle door. In some embodiments, the outside door lock and door handle interface member installs into the opening without using tools. Also, in some cases the outside door lock and door handle interface member is retained in position by the outside door handle assembly when the outside door handle assembly is installed into the opening.

The housing of the outside door lock and door handle interface member can be made of a die-cast zinc or other high-strength material element which interlocks with the sheet metal of the outer skin of the structural framework of the vehicle door. It will be appreciated by those skilled in the art that such a mounting arrangement can result in an enhanced level of security for the lock and latch system of the present invention.

In some embodiments, the outside door lock and door handle interface member is connected to two cables, although other types of linkages well known to those skilled in the art or a combination of such linkage elements and cables can also be used. For example, one cable can be used together with another type of mechanical linkage such as a rod. In such an arrangement, the cable can be used to connect the outside door handle to the latch while the pin can be used to connect the outside lock to the door latch. It will be appreciated by those skilled in the art that the use of cables can substantially enhance the level of security afforded by the lock and latch system of the present invention, since such cables are resistant to jimmying by a thief using a “slim jim.”

In those embodiments employing an outside door lock, the outside door lock can be installed into the outside door lock and door handle interface member, and can be accessible through the outside door handle assembly when these components are installed into the opening in the outer skin of the structural framework of the vehicle door. In some cases where cables extend from the outside door lock and door handle interface member, one of the cables in the outside door lock and door handle interface member can be driven by an outside door lock cable actuator which can be driven by the outside door lock. The outside door handle assembly can include a mechanical linkage which connects the outside door handle to an outside door handle cable actuator in the outside door lock and door handle interface member when the outside door handle assembly is installed. If desired, another cable in the outside door lock and door handle interface member can be driven by the outside door handle cable actuator, which can be driven by the linkage in the outside handle assembly.

In some embodiments, an inside door handle and an inside door lock actuator are both contained in a single assembly. Also, in some embodiments the inside door handle and inside door lock assembly are connected by two cables. One of the cables can be driven by the inside door handle, and the other cable can be driven by the inside door lock cable actuator. Those skilled in the art will readily appreciate that other types of linkages or a combination of such linkage elements and cables can instead be used.

If desired, cables can be employed to transfer mechanical force to the door latch. By way of example only, four cables can extend to the door latch from the outside door lock and door handle interface member and the inside door handle and inside door lock assembly. In some embodiments, the door latch used is the device described in U.S. patent application Ser. No. 09/408,993, entitled “Electronic Latch Apparatus and Method,” issued to Dimig and filed on Sep. 29, 1999, which is a continuation-in-part of U.S. Pat. No. 6,463,773 issued to Dimig and filed on Mar. 5, 1999. U.S. patent application Ser. No. 09/408,993 and U.S. Pat. No. 6,463,773, in their entirety, are hereby incorporated herein by reference.

In some embodiments, an electronic door latch is actuated by two cables: one cable extending from the inside door handle and operating a first control element in the electronic door latch, and another cable extending from the outside door handle and operating a second control element in the electronic door latch. A solenoid-actuated pin can be used to lock the electronic door latch, preventing it from being opened from the outside handle if the solenoid has retracted a pin from the second control element.

Although any lock and latch system can be employed in the present invention, in some embodiments the lock and latch system of the present invention uses the second embodiment of the electronic door latch illustrated in FIGS. 17-31 of the U.S. patent application Ser. No. 09/408,993 discussed above. In such cases, two cables can be respectively operatively connected to a solenoid armature such that movements of either of the cables can also be used to extend or retract the pin from the solenoid. Accordingly, the cables from either an inside door lock cable actuator or an outside door lock cable actuator can be operatively connected to the solenoid such that either of them can extend or retract the pin from the second control element. In some embodiments, two solenoids can instead be used, each corresponding to a respective control element. In such cases, cables operating the inside and outside locks can be connected to drive two pins, one of which is associated with each of the solenoids.

As mentioned above, in some embodiments the lock and latch system of the present invention is assembled into three modules which are delivered to the motor vehicle manufacturer. The first module can include the outside door lock and door handle interface member, the inside door handle and inside door lock assembly, the electronic door latch, and cables (e.g., four cables in some of the exemplary embodiments described above) connecting the first three components. This first module can be pre-assembled in its entirety, if desired. The second module can include the outside door lock, which can be part of a set of identically-keyed locks for installation into the doors, the ignition switch, and the trunk of the vehicle. The third module can include the outside door handle assembly (e.g., as assembly which includes the outside door handle itself, and in some cases the mechanical linkage which can be used to connect it to a handle cable actuator in the outside door lock and door handle interface member). The third module can also include the outside handle mounting mechanism which secures the outside door handle assembly in place when the outside door handle is actuated for the first time. In some embodiments, part of this third module is also located outside and partially overlying the lock cylinder, with the lock cylinder being accessible through this third module.

Some embodiments of the present invention provide a mounting bracket used to support an outside door lock and door handle interface member in a spaced relationship with respect to an electronic door latch. This mounting bracket can be both small and flexible, and can further facilitate installation of the components supported therefrom into the structural framework of a vehicle door. In some cases, the mounting bracket also extends between the inside door handle and inside door lock assembly and the electronic door latch in order to establish a spaced relationship therebetween.

In some embodiments, the lock and latch system includes the outside door handle as a separate modular component, thereby allowing outside door handles to be manufactured in a variety of colors to match exterior vehicle paint colors while allowing other modular components of the system to be of a single type and color. When employed according to the present invention, the pre-assembled nature of the modular components can reduce or eliminate the requirement for adjustments to be made during the assembly of the components of the lock and latch system into the structural framework of a vehicle door, thereby further minimizing assembly costs while simultaneously enhancing vehicle quality. The modular components can be adaptable for use on a variety of different vehicles by merely switching outside door handles and providing different size linkages between the various modular components.

The lock and latch system of the present invention can also be of a construction which is both durable and long lasting so that it requires little or no maintenance to be provided by the user throughout its operating lifetime. In order to enhance the market appeal of the lock and latch system of the present invention, it can also be of inexpensive construction to thereby afford it the broadest possible market.

Other features and advantages of the invention will become apparent to those skilled in the art upon review of the following detailed description, claims, and drawings.

### BRIEF DESCRIPTION OF THE DRAWINGS

FIG. 1 is a perspective view of the structural framework of a vehicle door from the outside, showing an opening in which the outside handle and outside lock will be mounted;

FIG. 2 is an elevational view of the structural framework of the vehicle door illustrated in FIG. 1 from the inside, with the locations at which the door latch, the outside handle and outside lock, and the inside handle and inside lock will be mounted highlighted;

FIG. 3 is an exploded view of an outside handle assembly constructed according to the teachings of the present invention, showing an aperture and a ball connector at the location at which an outside door lock and door handle interface member will be mounted;

FIG. 4 is a side view of the outside handle assembly illustrated in FIG. 3 from a first side and with the door handle in its normally retracted position, showing the linkage used to move the ball connector when the door handle is opened, and also showing a retention mechanism in a preinstalled position;

FIG. 5 is a side view of the outside handle assembly similar to the view illustrated in FIG. 4 but with the door handle in its extended position, showing the movement of the linkage and the ball connector, and also showing the retention mechanism in its installed position;

FIG. 6 is a side view of the outside handle illustrated in FIGS. 3 through 5 from a second side and with the door handle in its retracted position following movement of the retention mechanism to its installed position;

FIG. 7 is a plan view of an outside lock assembly from a first side, showing a pin extending from the rear end thereof,

FIG. 8 is a plan view of a portion of the outside lock assembly illustrated in FIG. 7 from a second side, showing the spring-loaded retention mechanism used to retain the outside lock assembly in place;

FIG. 9 is a plan view of the outside lock assembly illustrated in FIGS. 7 and 8 from the front end thereof;

FIG. 10 is a plan view of the outside lock assembly illustrated in FIGS. 7 through 9 from the rear end thereof,

FIG. 11 is a front plan view of an outside door lock and door handle interface member from the front side thereof, showing portions of two cables connected to the assembly, the interface member having a recess therein for receiving the outside lock assembly illustrated in FIGS. 7 through 10, the recess having an outside door lock cable actuator attached to one of the cables contained therein, and also showing a pivotable outside door handle cable actuator attached to the other of the cables at one end thereof and having a U-shaped fork at the other end thereof;

FIG. 12 is a side plan-view of the outside door lock and door handle interface member illustrated in FIG. 11, showing a recess located about the periphery of the housing of the interface member which will be used to mount the interface member;

FIG. 13 is a plan view of the cable actuator illustrated in FIG. 11;

FIG. 14 is a perspective view of the outside door handle cable actuator illustrated in FIG. 11, showing a centrally-located aperture extending therethrough, the curved end for attachment to the cable, and the U-shaped fork which is the other end thereof;

FIG. 15 is a front plan view of the outside door lock and door handle interface member illustrated in FIGS. 11 and 12 from the front side thereof, showing the outside lock assembly illustrated in FIGS. 7 through 10 installed therein;

FIG. 16 is a plan view of the portion of the outer skin of the structural framework of the vehicle door 40 (shown in FIG. 1) having the opening 42 therein, showing the installation and placement of the outside door lock and door handle interface member (shown in FIGS. 11, 12, and 15);

FIG. 17 is a perspective view of a door latch assembly from the front side, showing portions of four cables connected to the door latch assembly;

FIG. 18 is a rear perspective view of the door latch assembly of FIG. 16, showing how a striker mounted on the vehicle body is engaged and retained by a ratchet in the door latch assembly;

FIG. 19 is a plan view of an inside door handle and inside door lock assembly, showing portions of two cables connected to the assembly;

FIG. 20 is a plan view depicting the door latch assembly illustrated in FIGS. 17 and 18 and the outside door lock and door handle interface member illustrated in FIGS. 11, 12, and 15 with two cables interconnecting them, also showing two cables interconnecting the door latch assembly and the inside door handle and inside door lock assembly illustrated in FIG. 19, and also showing the outside door lock and door handle interface member positioned in engagement with the outside handle illustrated in FIGS. 3 through 6;

FIG. 21 is a schematic depiction from the side of a mounting bracket used to interconnect the door latch assembly illustrated in FIGS. 17 and 18 with the outside door lock and door handle interface member illustrated in FIGS. 11, 12, and 15, showing in dotted lines an optional extension of the door bracket which can be used to interconnect the door latch and the inside door handle and inside door lock assembly illustrated in FIG. 19, with the cables being omitted for clarity;

FIG. 22 is a schematic depiction of the mounting bracket similar to that illustrated in FIG. 21, but viewed from the top;

FIG. 23 is a perspective view of a door latch assembly according to another embodiment of the present invention;

FIG. 24 is a perspective view of a portion of the door latch assembly illustrated in FIG. 23;

FIG. 25 is a perspective view of the door latch of the door latch assembly illustrated in FIG. 23;

FIG. 26 is a perspective view of the outside interface member of the door latch assembly illustrated in FIG. 23;

FIG. 27 is a perspective view of the inside interface member of the door latch assembly illustrated in FIG. 23;

FIG. 28 is a perspective view of the outside door lock of the door latch assembly illustrated in FIG. 23;

FIG. 29 is a front perspective view of the outside door handle assembly of the door latch assembly illustrated in FIG. 23, shown with the outside door handle assembly in an actuated position;

FIG. 30 is a rear perspective view of the outside door handle assembly illustrated in FIG. 29;

FIG. 31 is a front view of the inside door handle assembly of the door latch assembly illustrated in FIG. 23;

FIG. 32 is a rear perspective view of the inside door handle assembly illustrated in FIG. 31;

FIG. 33 is an exterior view a door frame shown in hidden lines to illustrate the door latch assembly of FIG. 23 mounted to the door frame and located in a first position;

FIG. 34 is an interior view of the door frame shown in FIG. 33, illustrating the door latch assembly in the first position;

FIG. 35 is an exterior view of the door frame similar to FIG. 33, illustrating the door latch assembly moved to a second position;

FIG. 36 is an interior view of the door frame shown in FIG. 33, illustrating the door latch assembly in the second position;

FIG. 37 is an exterior view of an aperture in the door frame shown in FIG. 33;

FIG. 38 is a view similar to FIG. 37, illustrating the outside interface member positioned within the aperture;

FIG. 39 is a view similar to FIG. 38, illustrating the outside door lock received within the outside interface member;

FIG. 40 is a view similar to FIG. 39, illustrating the outside door handle assembly received within the aperture and in an actuated position;

FIG. 41 is an interior view of the structure illustrated in FIG. 40;

FIG. 42 is a view similar to FIG. 40, illustrating the outside door handle assembly in the de-actuated position;

FIG. 43 is an interior view of the structure illustrated in FIG. 42;

FIG. 44 is an interior view of a door in which the door latch assembly illustrated in FIGS. 23-43 has been partially installed, showing a trim panel attached to the door frame; and

FIG. 45 is an interior view similar to FIG. 44, illustrating an inside door handle received within an aperture of the trim panel.

FIG. 46 is a perspective view of an outside interface member according to another embodiment of the invention.

FIG. 47 is a front perspective view of the outside interface member of FIG. 46 assembled to a vehicle door.

FIG. 48 is an enlarged view of the outside interface member shown in FIG. 47.

FIG. 49 is a rear perspective view of the outside interface member shown in FIG. 47.

FIG. 50 is a rear perspective view of an outside door handle assembly according to another embodiment of the invention.

FIG. 51 is a rear perspective view of the outside interface member of FIG. 47 and the outside interface member of FIG. 50 assembled to a vehicle door.

FIG. 52 is a view similar to FIG. 51, illustrating the outside door handle in the deactuated position.

FIG. 53 is a rear perspective view of an outside interface member and an outside door handle assembly according to another embodiment of the invention.

FIG. 54 is a view similar to FIG. 53, illustrating the outside door handle in the deactuated position.

FIG. 55 is view similar to FIG. 54, illustrating the outside door handle moved to the actuated position.

FIG. 56 is a perspective view of an inside interface member according to another embodiment of the invention.

FIG. 57 is an exploded view of the inside interface member shown in FIG. 56.

FIGS. 58A-E are cross-section views of the inside interface member of FIG. 56, illustrating the assembly of a inside door handle assembly to the inside interface member.

FIG. 59 is a perspective view of an inside interface member according to another embodiment of the invention.

Before embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items. The use of letters to identify elements of a method or process is simply for identification and is not meant to indicate that the elements should be performed in a particular order.

### DETAILED DESCRIPTION OF THE PREFERRED EMBODIMENT

A first illustrated embodiment of an exemplary lock and latch system according to the present invention includes three modules which are pre-assembled prior to delivery to the manufacturer (i.e., a party assembling the motor vehicles into which the lock and latch system will be incorporated). In the first illustrated embodiment, the first module includes three primary components, namely an outside door lock and door handle interface member, an inside door handle and inside door lock assembly, and an electronic door latch, with four cables being used to connect these three components. These three components will be discussed separately, prior to a discussion about their incorporation into a single module. The second module is the outside lock, which in the exemplary first illustrated embodiment is a cylinder-type lock. The third module is the outside door handle assembly, which will also be discussed separately.

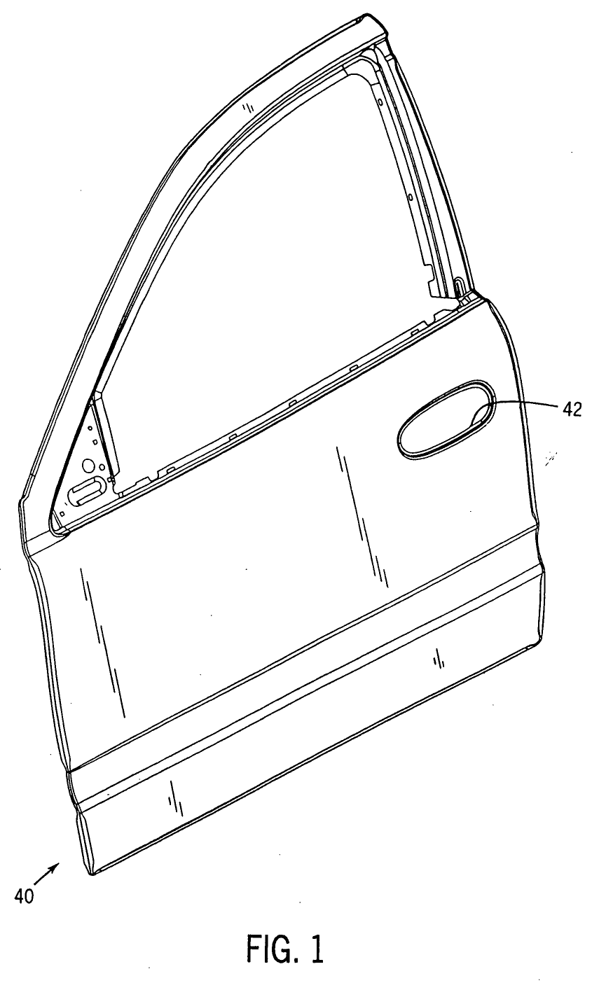

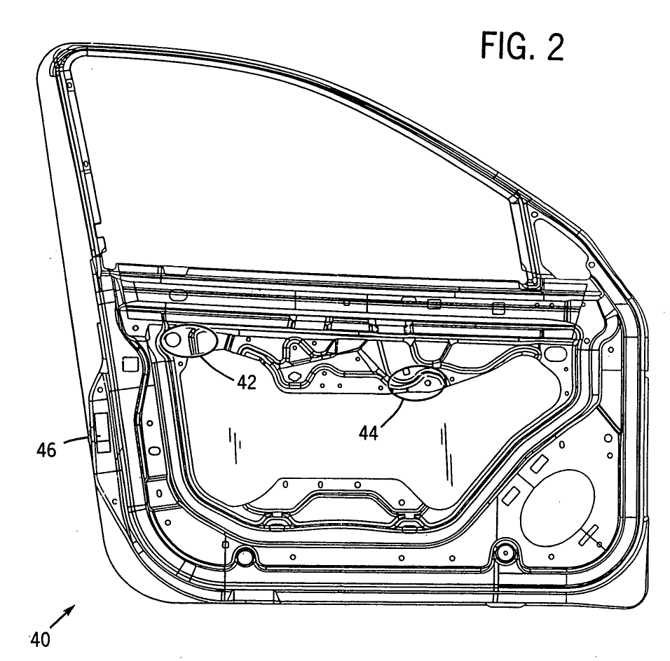

Referring first to FIGS. 1 and 2, the structural framework of a vehicle door 40 is illustrated from the outside in FIG. 1 and from the inside in FIG. 2. The structural framework of the vehicle door 40 has an opening 42 in the outer skin of the structural framework of the vehicle door 40 (best illustrated in FIG. 1, illustrated schematically in FIG. 2) into which an outer handle assembly and an outside door lock (neither of which are illustrated in FIGS. 1 and 2) will be mounted. The structural framework of the vehicle door 40 also has the location for an inside door handle and inside door lock assembly (not illustrated in FIGS. 1 or 2) indicated by the reference numeral 44 in FIG. 2 and the location for a door latch (not illustrated in FIGS. 1 or 2) indicated by the reference numeral 46 in FIG. 2.

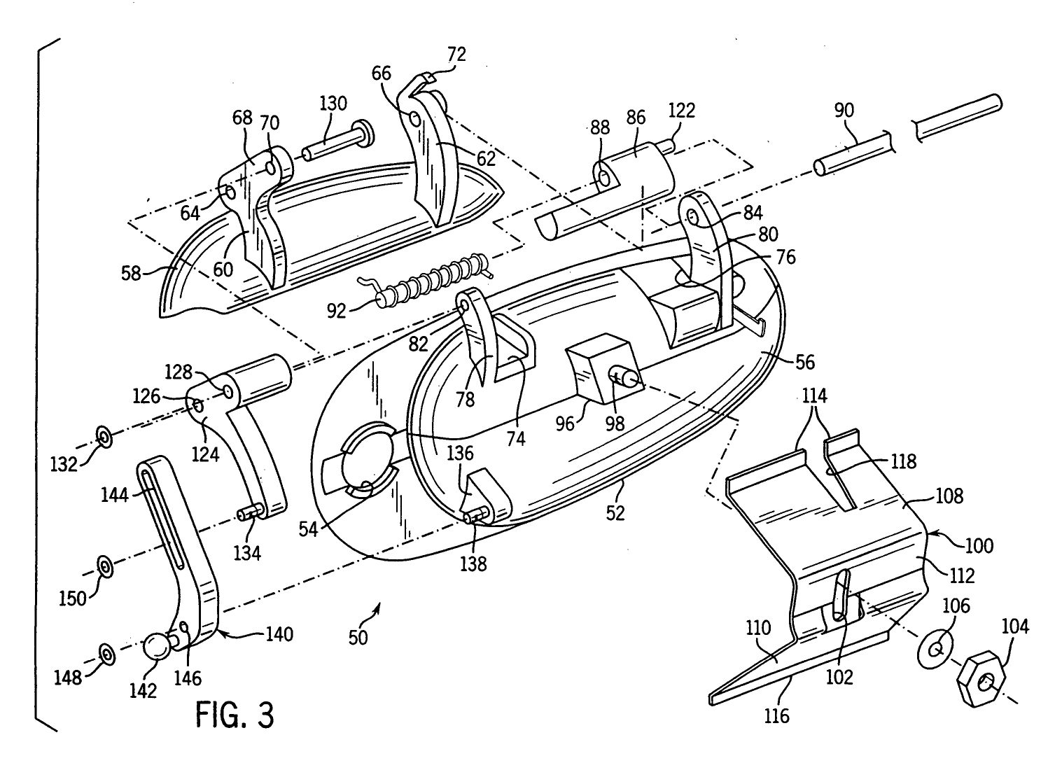

Referring next to FIGS. 3 through 6, the construction of an exemplary outside door handle assembly 50 according to the present invention is illustrated. In this embodiment, all of the various components of the outside door handle assembly 50 are assembled onto an outside door handle housing member 52, which is of a size and configuration to fit partially into the opening 42 in the outer skin of the structural framework of the vehicle door 40 (shown in FIG. 1). The outer periphery of the outside door handle housing member 52 is larger than the opening 42 in the outer skin of the structural framework of the vehicle door 40.

Located near one side of the outside door handle housing member 52 is an aperture 54 which will receive the proximal end (the end next to or nearest the point of attachment or origin) of an outside door lock (not illustrated in FIGS. 3 through 6). Located intermediate the aperture 54 and the other end of the outside door handle housing member 52 is a concave portion 56 which will receive a user-manipulatable control (e.g., an outside door handle 58) therein in a flush manner when the outside door handle 58 is not actuated.

The outside door handle 58 in the illustrated embodiment of FIGS. 3-6 has two support arms 60 and 62 located near opposite ends thereof. The support arm 60 has an aperture 64 located near the end thereof remote from the point of attachment of the support arm 60 to the outside door handle 58. The support arm 62 has an aperture 66 located near the end thereof remote from the point of attachment of the support arm 62 to the outside door handle 58.

The support arm 60 has an extension 68 projecting in the same plane as the support arm 60 from the end thereof remote from the point of attachment of the support arm 60 to the outside door handle 58. The distal end (the end situated away from the point of attachment or origin) of the extension 68 has an aperture 70 located therein. The support arm 62 has a projection 72 extending from the side thereof near the end thereof remote from the point of attachment of the support arm 62 to the outside door handle 58.

The outside door handle housing member 52 has two openings 74 and 76 located near opposite ends of the concave portion 56 to admit the support arms 60 and 62, respectively, therethrough. Extending from the outside door handle housing member 52 on the back side of the concave portion 56 immediately outside the openings 74 and 76 are two handle mounting arms 78 and 80. The handle mounting arms 78 and 80 have apertures 82 and 84, respectively, located near their ends which are remote from their point of attachment to the outside door handle housing member 52.

The mechanism used to mount the outside door handle assembly 50 can be conventional or similar to the apparatus disclosed in U.S. Pat. No. 5,706,554, which is incorporated herein by reference. In the exemplary embodiment of the outside door handle assembly 50 illustrated in FIGS. 3-6, a cam member 86 having an aperture 88 extending therethrough is mounted adjacent the handle mounting arm 80 using a pin 90. Also mounted on the pin 90 is a spring 92, which bears against the support arm 60 of the outside door handle 58 and the inside surface of the outside door handle housing member 52, and operates to keep the outside door handle 58 in its flush position with respect to the outside door handle housing member 52.

The pin 90 extends sequentially through the aperture 84 in the handle mounting arm 80, the aperture 66 in the support arm 62 of the outside door handle 58, the aperture 88 in the cam member 86, the spring 92, the aperture 64 in the support arm 60, and the aperture 82 in the handle mounting arm 78. In the first illustrated embodiment, the pin 90 has an interference fit with one or both of the apertures 82 and 84 in the handle mounting arms 78 and 80, respectively, although other ways of retaining the pin 90 in place will be readily apparent to those skilled in the art.

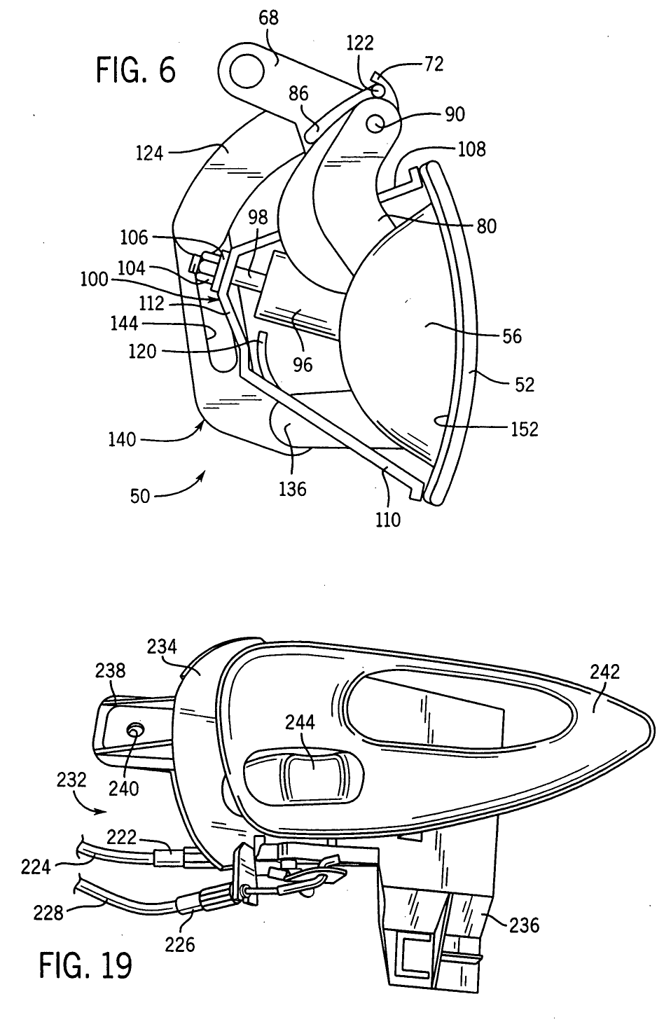

Extending from the back side of the concave portion 56 of the outside door handle housing member 52 is an essentially square lock support post 96, which is located between and slightly below the level of the handle mounting arms 78 and 80. Extending from the distal end of the lock support post 96 is a threaded post 98. Mounted on the threaded post 98 is a lock plate 100 which has a vertical slot 102 therein through which the threaded post 98 extends. A nut 104 and a washer 106 are used to retain the lock plate 100 in place on the threaded post 98, although, as can best be seen in FIGS. 5 and 6, the nut 104 is not fully tightened on the threaded post 98. Other manners of retaining the lock plate 100 in place on the threaded post 98 which will be readily apparent to those skilled in the art may alternatively be used.

The exemplary lock plate 100 of the illustrated embodiment in FIGS. 3-6 can be seen as having three primary portions (i.e., two planar portions 108 and 110 both connected to an irregular central portion 112). The vertical slot 102 in this embodiment is located in the irregular central portion 112. The two planar portions 108 and 110 are at an angle of approximately 60 degrees with respect to each other, and each have a small outwardly extending flange 114 and 116 located at its respective distal edge. A slot 118 is located in the distal edge of the planar portion 108 to admit the end of the spring 92 which bears on the outside door handle housing member 52.

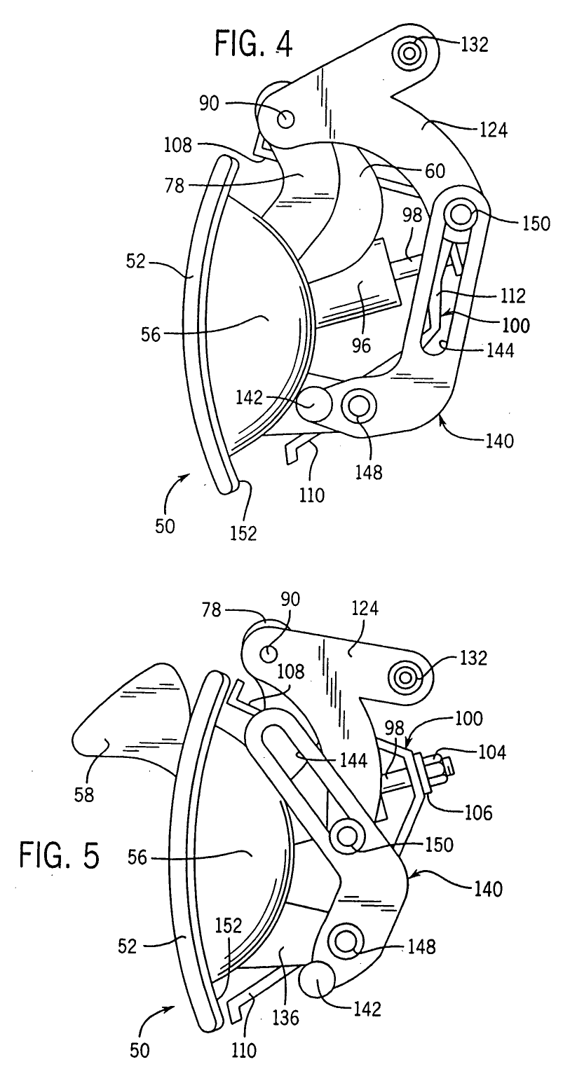

Note that when the lock plate 100 is in the position illustrated in FIG. 4 (the installation position), the flange 114 on the planar portion 108 of the lock plate 100 is spaced slightly away from the top edge of the outside door handle housing member 52, and the flange 116 on the planar portion 110 of the lock plate 100 is spaced well away from the bottom edge of the outside door handle housing member 52. In this position, the outside door handle assembly 50 can be installed into place in the opening 42 in the outer skin of the structural framework of the vehicle door 40 (shown in FIG. 1).

The irregular central portion 112 is configured such than when the lock plate 100 is moved downward from the position illustrated in FIG. 4 to the position illustrated in FIGS. 5 and 6 (the installed position), the flanges 114 and 116 will move into close contact with the top and bottom edges of the outside door handle housing member 52. Once in this position, a finger 120 extending from the planar portion 110 near its point of attachment to the irregular central portion 112 will prevent the lock plate 100 from returning to its former position, thereby gripping the steel surrounding the opening 42 in the outer skin of the structural framework of the vehicle door 40 (shown in FIG. 1) tightly.

The lock plate 100 in the illustrated exemplary embodiment is moved from its installation position to its installed position by the clockwise rotation of the cam member 86 when viewed along the axis of the pin 90 from the perspective of the handle mounting arm 78. This movement of the cam member 86 occurs when the outside door handle 58 is actuated (pulled outwardly from the concave portion 56 in the outside door handle housing member 52). The projection 72 on the support arm 62 of the outside door handle 58 bears against a pin 122 extending from the side of the cam member 86 facing the handle mounting arm 80, causing the cam member 86 to rotate against the planar portion 108 of the lock plate 100, pushing it downward from the installation position to the installed position.

A T-shaped linkage member 124 is mounted onto the support arm 60 which extends from the outside door handle 58. The T-shaped linkage member 124 has apertures 126 and 128 extending through opposite ends of the top of the T. The end of the pin 90 preferably extends beyond the aperture 64 in the support arm 60 and into the aperture 126 in the T-shaped linkage member 124.

A bolt 130 extends through the aperture 70 in the support arm 60 and the aperture 128 in the T-shaped linkage member 124, and is secured in place by a nut 132. The base of the T is curved, as best seen in FIG. 4. Extending from the side of the T-shaped linkage member 124 at the bottom of the T is a mounting post 134 which has a threaded distal tip.

A linkage support arm 136 extends from the back of the outside door handle housing member 52 well below the position of the handle mounting arm 78. Extending from the side of linkage support arm 136 near the distal end thereof is a mounting post 138 which has a threaded distal tip.

Mounted on the mounting post 138 is an intermediate linkage member 140 which is shaped like a hockey stick in some embodiments. Mounted on the side of the lower end of the intermediate linkage member 140 at the distal tip thereof is a ball 142 which will interface with an outside door lock and door handle interface member (not illustrated in FIGS. 3 through 6). Located in the side of the intermediate linkage member 140 from the top to a position about two-thirds of the way down the “handle” is a slot 144. Also located on the side of the lower end of the intermediate linkage member 140 proximally from the ball 142 is an aperture 146.

The intermediate linkage member 140 is mounted onto the linkage support arm 136 with the mounting post 138 extending through the aperture 146 in the intermediate linkage member 140. The mounting post 134 of the T-shaped linkage member 124 extends through the slot 144 in the intermediate linkage member 140. A nut 148 is screwed onto the threaded distal tip of the mounting post 138 to retain the intermediate linkage member 140 in place on the mounting post 138. A nut 150 is screwed onto the threaded distal tip of the mounting post 134 to retain the mounting post 134 in the slot 144 of the intermediate linkage member 140.

Referring now particularly to FIGS. 4 and 5 of the exemplary illustrated embodiment, it will be appreciated by those skilled in the art that the ball 142 on the intermediate linkage member 140 moves vertically (and to a lesser extent horizontally) as the outside door handle 58 goes from a fully retracted position in FIG. 4 to a fully actuated position in FIG. 5. This movement of the ball 142 can be used to operate a handle cable actuator in the outside door lock and door handle interface member (not illustrated in FIGS. 3 through 6).

Finally, FIGS. 4 through 6 also show a mounting gasket 152 which is placed on the inside of the outside door handle housing member 52 around the perimeter thereof. The mounting gasket 152 can be located intermediate the inside of the outside door handle housing member 52 and the steel of the outer skin of the structural framework of the vehicle door 40 (shown in FIG. 1) when the outside door handle assembly 50 is installed on the structural framework of the vehicle door 40. In the illustrated embodiment, the outside door handle housing member 52 and the outside door handle 58 can both be made of molded plastic material.

By way of example only, the outside door handle 58 can be a paddle type or a pull strap type door handle used in conjunction with the lock and latch system of the present invention. In addition, either of these types of door handles can alternately be mounted and pivot with respect either to an outside door handle housing member which is a part of the second component, to the sheet metal outer skin or other structural framework of a vehicle door, or to an outside door lock and door handle interface member. Such changes and substitutions will certainly be readily apparent to one skilled in the art once the principles of the present invention have been made known to that person.

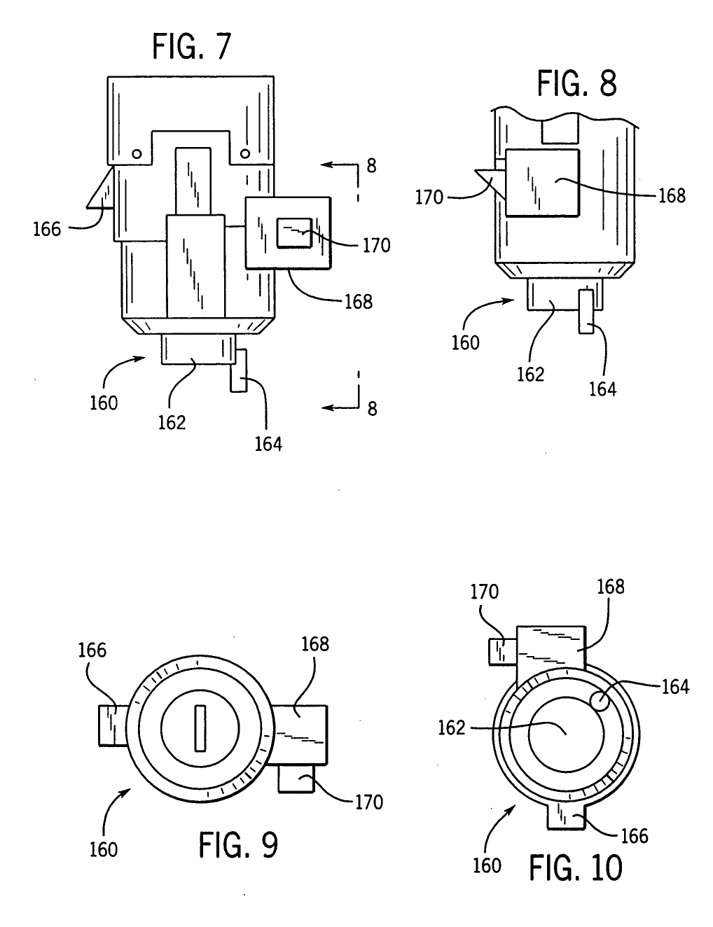

Referring next to FIGS. 7 through 10, an outside door lock 160 is illustrated. This user-manipulatable control 160 is a cylinder-type lock having a proximal end (best shown in FIG. 9) into which a key (not shown herein) can be inserted. If the correct key is inserted into the outside door lock 160 and is turned, a cylindrical projection 162 located at the distal end of the outside door lock 160 will turn. Located on one side of the cylindrical projection 162 (best shown in FIG. 10) is a pin 164 which extends from the distal end of the cylindrical projection 162 and rotates with the cylindrical projection 162 when the correct key is inserted into the outside door lock 160 and is turned.

Located on one side of the outside door lock 160 in the exemplary embodiment of FIGS. 7-10 is a small projection 166, while located on the other side of the outside door lock 160 is a larger projection 168. The larger projection 168 can be wider than is the small projection 166, as best shown in FIGS. 9 and 10. This ensures the proper orientation of the outside door lock 160 when it is inserted into an outside door lock and door handle interface member (not illustrated in FIGS. 7 through 10). Extending from one side of the larger projection 168 is a spring-loaded tapered projection 170 which will be used to retain the outside door lock 160 in the outside door lock and door handle interface member when it is so installed.

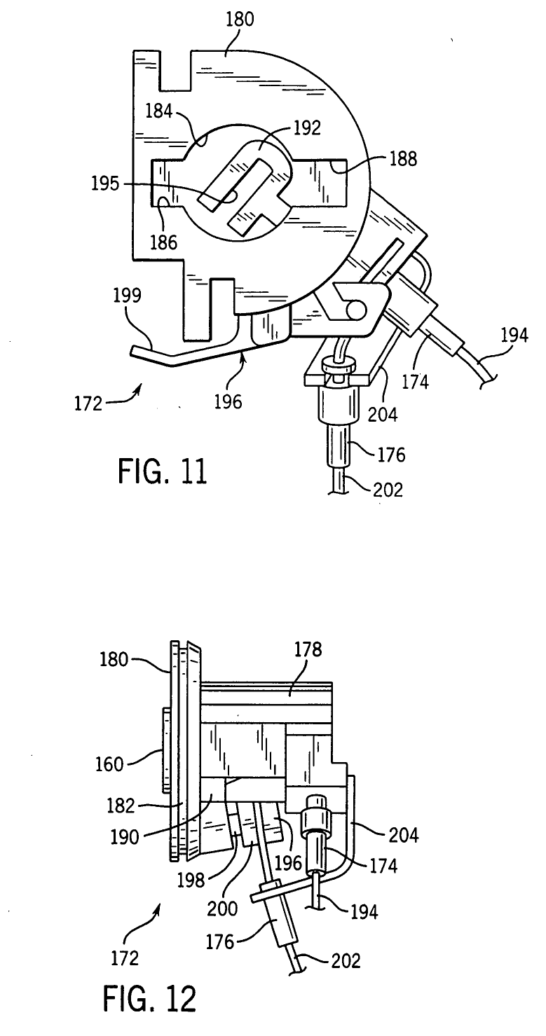

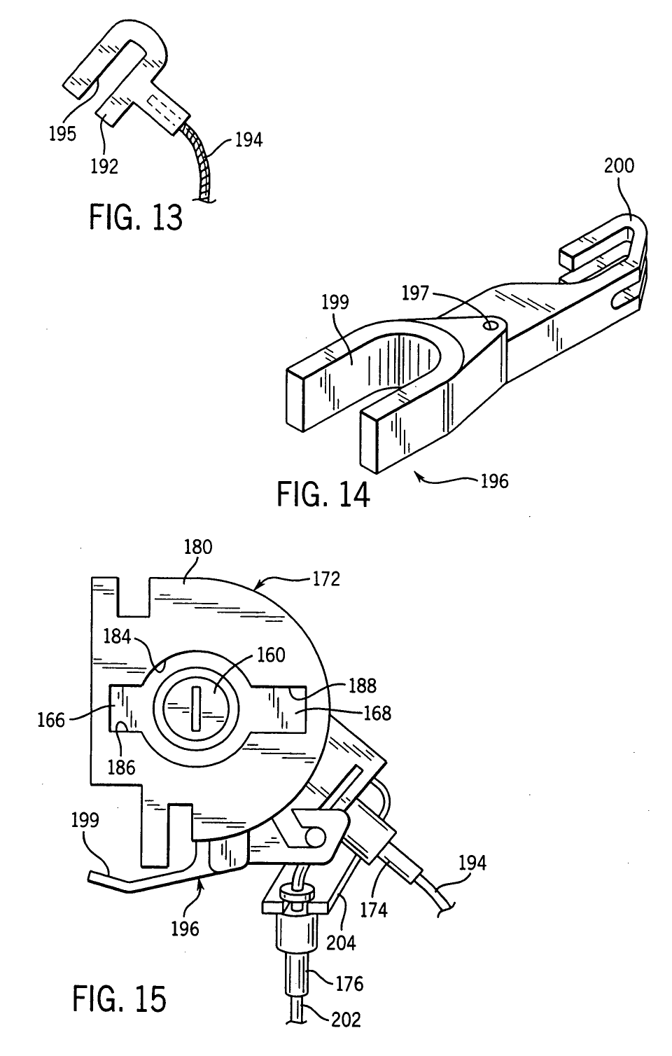

Referring now to FIGS. 11 through 15, an exemplary outside door lock and door handle interface member 172 (and, in FIGS. 13 and 14, two components thereof) according to the present invention is illustrated. The outside door lock and door handle interface member 172 can serve any one or more of three functions: to provide a mounting location for the outside door lock 160 (shown in FIGS. 7 through 10); to provide a coupling mechanism for interfacing rotary motion of the cylinder lock in the outside door lock 160 to linear motion in an outside door lock cable 174; and to provide a coupling mechanism for interfacing movement of the ball 142 of the intermediate linkage member 140 (best illustrated in FIGS. 4 and 5, which occurs when the outside door handle 58 is actuated) to linear motion in an outside door release cable 176.

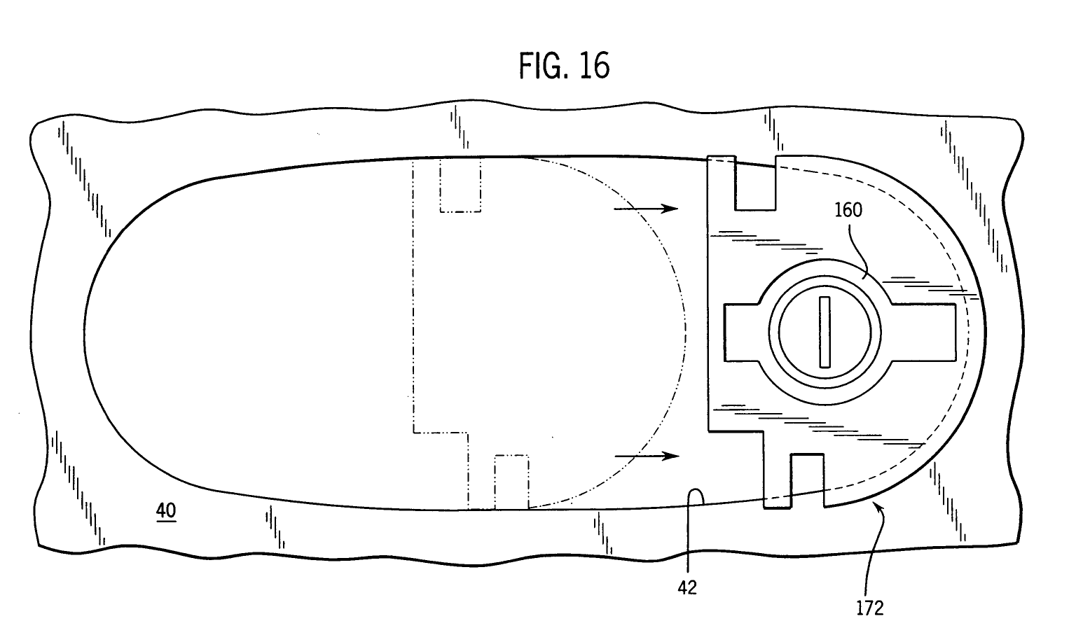

The outside door lock and door handle interface member 172 includes a housing member 178 which is hollow at one end to receive the outside door lock 160 (an example of which is illustrated in FIGS. 7 through 10) therein. The end of the housing member 178 which has the opening therein can have an enlarged head portion 180 having a contoured recess 182 located in a portion of the sides thereof. This contoured recess 182 is configured to precisely fit the opening 42 in the outer skin of the structural framework of the vehicle door 40 (shown in FIGS. 1 and 16), with the portions of the enlarged head portion 180 surrounding the recess on both sides thereof acting to retain the outside door lock and door handle interface member 172 in place in the opening 42.

Referring for the moment to FIG. 16, the outside door lock and door handle interface member 172 can be installed into the opening 42 in the outer skin of the structural framework of the vehicle door 40 (illustrated in FIG. 1) by placing it into the center of the opening 42 (which can be wider than at the ends of the opening 42) where it is shown in phantom lines, and sliding it (in the direction of the arrows) into place at an end of the opening 42. In this position, the sheet metal at the right side of the opening 42 in the outer skin of the structural framework of the vehicle door 40 will be engaged within the contoured recess 182 of the outside door lock and door handle interface member 172. The outside door handle assembly 50 (illustrated in FIGS. 3 through 6) can then be installed into the opening 42, where it will engage the outside door lock and door handle interface member 172 and retain it in place.

Referring again to FIGS. 11 through 15, the opening in the outside door lock and door handle interface member 172 has a cylindrical opening portion 184 which is centrally located therein, with a narrower rectangular opening portion 186 on one side thereof and a wider rectangular opening portion 188 on the other side thereof. A retaining bar 190 (as best seen in FIG. 12) is located on one side of the cylindrical opening portion 184 to engage the spring-loaded tapered projection 170 of the outside door lock 160 when it is installed in the outside door lock and door handle interface member 172.

It may be seen in FIG. 12 that the outside door lock 160, when installed in the outside door lock and door handle interface member 172, extends slightly beyond the surface of the enlarged head portion 180. This portion of the outside door lock 160 will fit into the aperture 54 of the outside door handle housing member 52 (illustrated in FIG. 3) when the outside door lock and door handle interface member 172 and the outside door handle housing member 52 are installed into the opening 42 in the outer skin of the structural framework of the vehicle door 40 (as illustrated in FIG. 16). It will be appreciated by those skill in the art that typically the outside door lock 160 is included in a set of identically-keyed locks for installation into the doors, the ignition switch, and the trunk of the vehicle. Accordingly, in some cases the outside door lock 160 will not be installed into the outside door lock and door handle interface member 172 until the lock and latch system is being installed into a motor vehicle.

Located in the back of the cylindrical opening portion 184 in the exemplary housing member 178 is an outside door lock cable actuator 192 (which is best shown in FIG. 13). The outside door lock cable actuator 192 is U-shaped, with the middle of one side of the U being connected to one end of a cable wire 194. The cable wire 194 is located inside the outside door lock cable 174. The pin 164 on the cylindrical projection 162 of the outside door lock 160 (best illustrated in FIGS. 8 and 10) will fit inside the interior of the U (which is identified by the reference number 195) when the outside door lock 160 is installed into the outside door lock and door handle interface member 172.

Thus, it will be appreciated by those skilled in the art that when a key (not illustrated herein) is placed into the outside door lock 160 and rotated, rotating the cylindrical projection 162 and the pin 164, the pin 164 will actuate the outside door lock cable actuator 192 and cause the cable wire 194 to be moved inside the outside door lock cable 174.

Also mounted on the exemplary outside door lock and door handle interface member 172 illustrated in FIGS. 11-15 is an outside door handle cable actuator 196 (which is best shown in FIG. 14). The outside door handle cable actuator 196 has an aperture 197 which is centrally located therein, and is pivotally mounted on a pivot pin 198 extending from the side of the housing member 178. One end of the outside door handle cable actuator 196 is U-shaped (as identified by the reference numeral 199), and this U-shaped end 199 will engage the ball 142 on the intermediate linkage member 140 of the outside door handle assembly 50 (illustrated in FIGS. 4 and 5). The other end of the outside door handle cable actuator 196 (which is indicated generally by the reference numeral 200) is connected to one end of a cable wire 202. The cable wire 202 is located inside the outside door lock cable 176. The outside door lock cable 176 is secured to the outside door lock and door handle interface member 172 by a bracket 204.

Thus, it will be appreciated by those skilled in the art that when the outside door handle 58 of the outside door handle assembly 50 (illustrated in FIGS. 4 and 5) is actuated, the ball 142 on the intermediate linkage member 140 will move, causing a corresponding movement of the outside door handle cable actuator 196. As the outside door handle cable actuator 196 moves, the cable wire 202 inside the outside door release cable 176 will move as well.

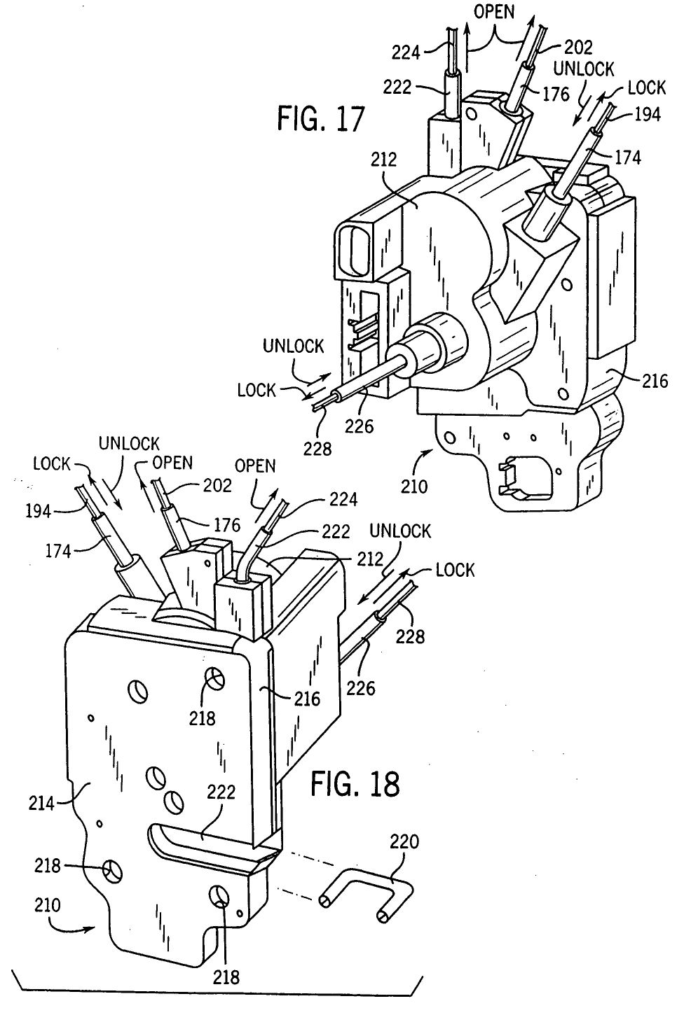

Referring now to FIGS. 17 and 18, an electronic door latch 210 employed in an exemplary embodiment of the present invention is illustrated. By way of example only, this door latch 210 is the second illustrated electronic door latch embodiment in FIGS. 17-31 of U.S. patent application Ser. No. 09/408,993, which is hereby incorporated by reference insofar as it relates to vehicle door latches, their manner of operation, and the manner in which such latches are connected to latch inputs. The electronic door latch 210 in FIGS. 17 and 18 uses two cables which are respectively operatively connected to a solenoid (not shown) within the latch 210 such that movements of the cables can also be used to extend or retract a pin (e.g., an armature of the solenoid) from one or two control elements (e.g., levers located within the latch 210 and movable to trigger release of the striker 220). Rather than repeat the extensive technical description of the electronic door latch described in U.S. patent application Ser. No. 09/408,993, only the application of this latch will be described herein.

FIGS. 17 and 18 illustrate the exemplary electronic door latch 210, which has a front cover 212, a rear mounting plate 214, and a housing 216, together enclosing the internal elements and mechanisms of the electronic door latch 210. The rear mounting plate 214 has a plurality of threaded apertures 218 which can be utilized to secure the electronic door latch 210 to the structural framework of the vehicle door 40 (in the position illustrated in FIG. 2).

The electronic door latch 210 operates to secure the vehicle door 40 by releasably engaging and retaining a striker 220 mounted on a vehicle body (not illustrated herein). The electronic door latch 210 utilizes a ratchet 222 (also known as a fork bolt) which is rotatably mounted within the housing 216. The exemplary electronic door latch 210, like the electronic door latch described in U.S. patent application Ser. No. 09/408,993, has two control elements located therein.

In the illustrated embodiment, two of the cables attached to the electronic door latch 210 are actuated by the outside door handle 58 (illustrated in FIG. 5) and the inside door handle (which has not yet been described herein), respectively. The outside door release cable 176 is secured to the housing 216, and has a cable wire 202 contained therein. The end of the cable wire 202 is attached to a control element, which is entirely contained within the housing 216. An inside door release cable 222 is secured to the housing 216, and has a cable wire 224 contained therein. The end of the cable wire 224 is connected to another control element, which is also entirely contained within the housing 216.

The outside door lock cable 174 is connected to the front cover 212, and contains the cable wire 194. An inside door lock cable 226 is also connected to the front cover 212, and contains a cable wire 228. In the exemplary embodiment illustrated herein, the outside door lock cable 174 and the inside door lock cable 226 are both used to lock the one of the control elements. When this control element is locked, and the outside door release cable 176 is pulled, the electronic door latch 210 will not unlatch. However, when this same control element is unlocked, and the outside door release cable 176 is pulled, the electronic door latch 210 will unlatch. For more complete understanding of the operation of the illustrated electronic door latch 210, the reader is referred to U.S. patent application Ser. No. 09/408,993. In the illustrated embodiment of the present invention, one control element corresponding to the inside door handle is never locked (although it will be appreciated by those skilled in the art that it can be locked if the inside door lock cable 226 was connected to it instead of the other control element).

Referring next to FIG. 19, an inside door handle and inside door lock assembly 232 according to an exemplary embodiment of the present invention is illustrated for installation in the location 44 on the structural framework of the vehicle door 40 (illustrated in FIG. 2). The inside door handle and inside door lock assembly 232 has a base member 234 having a mounting stub 236 on the bottom edge thereof and a mounting tab 238 having an aperture 240 therethrough on the left side edge thereof. An user-manipulatable control (e.g., an inside door handle 242) is hingedly mounted onto the base member 234, and is biased into the position illustrated in FIG. 19.

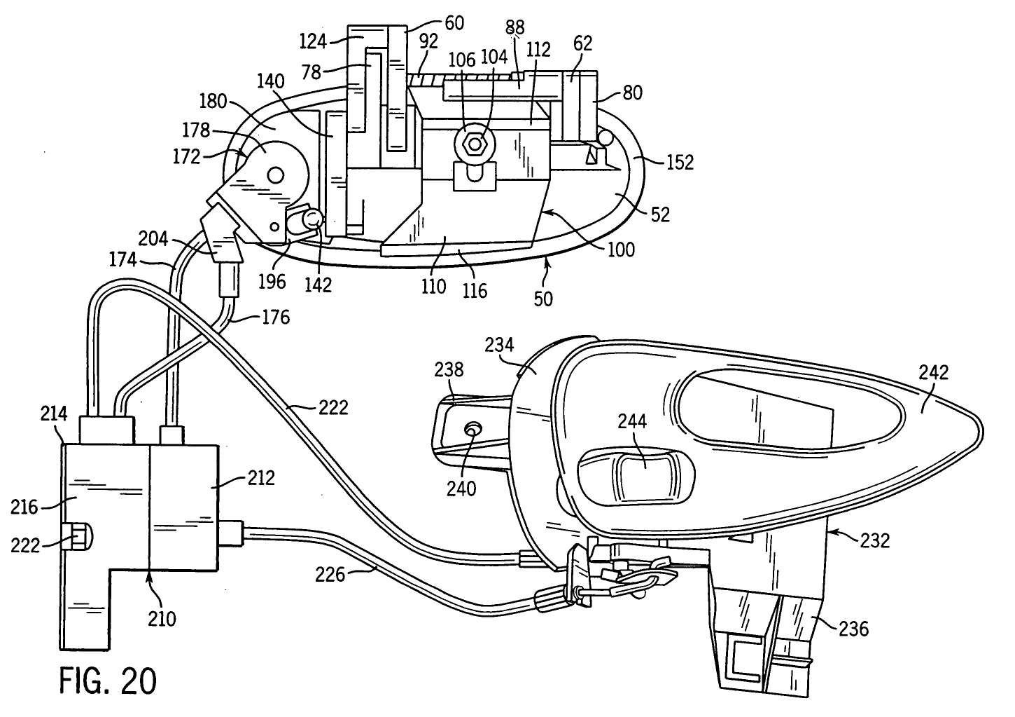

Actuating the inside door handle 242 illustrated in FIG. 20 is accomplished by pulling its unconnected end outwardly from the base member 234, which pulls the cable wire 224 from the end of the inside door release cable 222 shown in FIG. 19. A user manipulatable control (i.e., an inside door lock actuator 244) is also shown in FIG. 19 to be of the rocker type. Pushing on its right side (as shown in FIG. 19) pulls the cable wire 228 from the end of the inside door lock cable 226 shown in FIG. 19, locking the electronic door latch 210 (shown in FIGS. 17 and 18). Pushing on the left side of the inside door lock actuator 244 pushes the cable wire 228 back into the inside door lock cable 226, unlocking the electronic door latch 210. The mechanisms used to connect the inside door handle 242 to the inside door release cable 222 and the inside door lock actuator 244 to the inside door lock cable 226 are not shown in greater detail since they are of a simple nature which will be readily apparent to one skilled in the art. In addition, one skilled in the art will also appreciate that instead of the inside door handle and inside door lock assembly 232 being used, a separate inside door handle assembly (not illustrated herein) and inside door lock assembly (not illustrated herein) can instead be used.

In some alternative embodiments of the present invention, the inside door handle and inside door lock assembly 232 comprise a fourth component which is not initially connected to the rest of the first component (the electronic door latch 210, the outside door handle assembly 50, and the cables between components 174, 176, 222, and 226). In such embodiments, the first component can, however, include cables 222 and 226 which will be connected to the mechanism of the inside door handle and inside door lock assembly 232.

While the rest of the first component is installed in the structural framework of the vehicle door 40, these cables 222 and 226 can be extended out of the vehicle door 40 to allow them to be connected to the inside door handle and inside door lock assembly 232. Thus, in such embodiments, following the connection of the first and fourth components together, the inside door handle and inside door lock assembly 232 can be installed into the structural framework of the vehicle door 40.

Referring now to FIG. 20, the entire lock and latch system of an exemplary embodiment of the present invention is illustrated in an assembled form. Note particularly the four cables between the components. The outside door lock cable 174 and the outside door release cable 176 extend between the outside door lock and door handle interface member 172 and the electronic door latch 210, and the inside door release cable 222 and the inside door lock cable 226 extend between the inside door handle and inside door lock assembly 232 and the electronic door latch 210. In one embodiment, the cables are Bowden cables which transfer the motions of the various handles and lock mechanisms to the door latch.

It will be appreciated by those skilled in the art that other types of linkage or a combination of such other types of linkage elements together with cables can be used instead of an all-cable system. For example, a substitute which can be made for one of the cables is another type of mechanical linkage such as a pin. In such an arrangement, the pin can be used, for example, to connect the outside lock to the door latch instead of using the outside door lock cable 174. It will, however, be appreciated by those skilled in the art that the use of cables can substantially enhance the level of security afforded by the lock and latch system of the present invention since such cables can be less susceptible to jimmying by a thief using a “slim jim.”

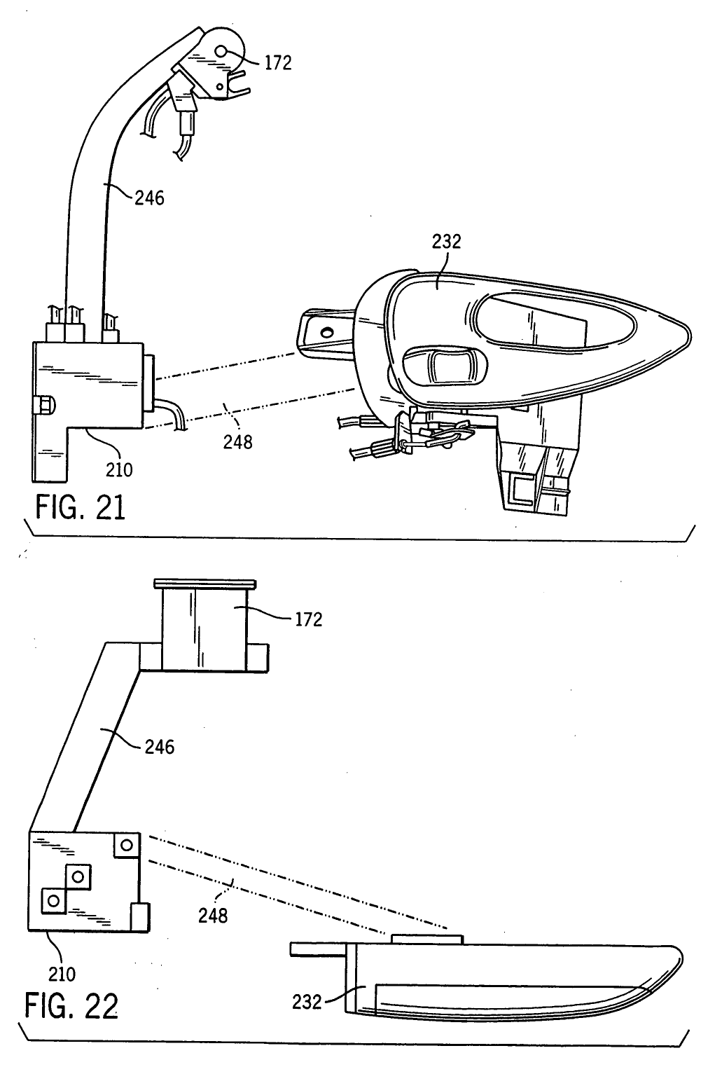

Referring finally to FIGS. 21 and 22, a sheet metal mounting support bracket 246 is schematically illustrated as extending between the outside door lock and door handle interface member 172 and the electronic door latch 210. The mounting support bracket 246 can be used to properly space the outside door lock and door handle interface member 172 and the electronic door latch 210 apart, and in some embodiments will be different for each different vehicle door configuration. Accordingly, the mounting support bracket 246 can have a plurality of bends and curves contained therein which are arranged and configured in accordance with the particular vehicle door configuration, as well as to accommodate the various components to be assembled into the vehicle door.

In a permutation of the mounting support bracket 246, an additional segment of mounting support bracket 248 can extend between the inside door handle and inside door lock assembly 232 and the electronic door latch 210. The mounting support bracket 248 can be used to properly space the inside door handle and inside door lock assembly 232 and the electronic door latch 210 apart, and in some embodiments will again be different for each different vehicle door configuration. In addition, the mounting support bracket 248 can also have a plurality of bends and curves contained therein which are again arranged and configured in accordance with the particular vehicle door configuration, as well as to accommodate the various components to be assembled into the vehicle door.

It will therefore be appreciated from the above detailed description of the embodiments of the present invention that a locking and latching system of modular construction is taught, in which the components of the system can be pre-assembled prior to their installation into the structural framework of a vehicle door. The modular construction of the lock and latch system can include the outside and inside door handles, the outside and inside locks, the door latch itself, as well as linkages between these components. The modular components of the present invention can facilitate the assembly process by, for example, being of a design which simplifies the process of installing them into the structural framework of a vehicle door, without requiring the use of specialized tools, thereby reducing the labor costs associated with assembly. The lock and latch system can substantially enhance the security of the vehicle by providing a lock and latch system which by virtue of its design has an enhanced level of resistance to manipulation by jimmying with a “slim jim” or similar tool of the type commonly used by car thieves.

The lock and latch system can include the outside door handle as a separate modular component, thereby allowing outside door handles to be manufactured in a variety of colors to match exterior vehicle paint colors while allowing the other modular components of the system to be of a single type and color. The pre-assembled nature of the modular components can eliminate the requirement for adjustments to be made during the assembly of the components of the lock and latch system into the structural framework of a vehicle door, thereby further minimizing assembly costs while simultaneously enhancing vehicle quality. The modular components of the lock and latch system in some embodiments of the present invention can be adaptable for uses on a variety of different vehicles by merely switching outside door handles and providing different size linkages between the various modular components.

The lock and latch system of the present invention can be of a construction which is both durable and long lasting, and which requires little or no maintenance to be provided by the user throughout its operating lifetime. The lock and latch system of the present invention can also be of inexpensive construction to enhance its market appeal and to thereby afford it the broadest possible market.

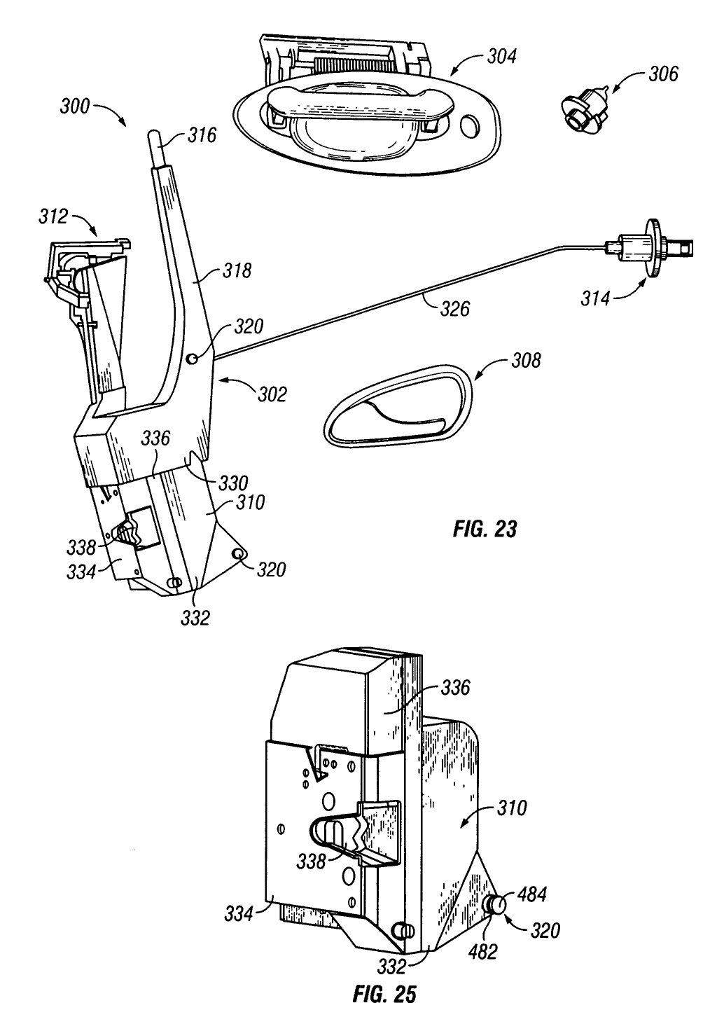

Another embodiment of the present invention is illustrated in FIGS. 23-45. FIG. 23 of this exemplary embodiment illustrates a door latch assembly 300 that includes a latch assembly 302, an outside door handle assembly 304, an outside door lock 306, and an inside door handle assembly 308. Some embodiments of the present invention do not employ all of these components, and any number of these components can be used in other embodiments.

As best illustrated in FIG. 23, the latch assembly 302 includes a latch 310, an outside interface member 312 coupled to the latch 310, an inside interface member 314 coupled to the latch 310, and an inside door lock assembly coupled to the latch 310. In this embodiment, the inside door lock assembly is a sill button 316. In other embodiments, the inside door lock assembly can be a lock switch that is part of the inside door handle assembly 308. The latch assembly 302 does not need to include all of the components 312, 314, 316, and any number of these components can be used together in other embodiments.

The latch assembly 302 can include a resilient bracket 318 attached between the latch 310 and at least one of the outside interface member 312 and the sill button 316. In some embodiments (such as that shown in FIG. 23), the same resilient bracket is attached to the latch 310, outside interface member 312, and sill button 316, while in others, dedicated resilient brackets can extend from the latch 310 to the outside interface member 312 and/or from the latch 310 and the sill button 316. In some embodiments, the latch assembly 302 includes a first projection, or pin 320, that extends outwardly from the bracket 318, and/or a second projection, or pin 320, that extends outwardly from the latch 310.

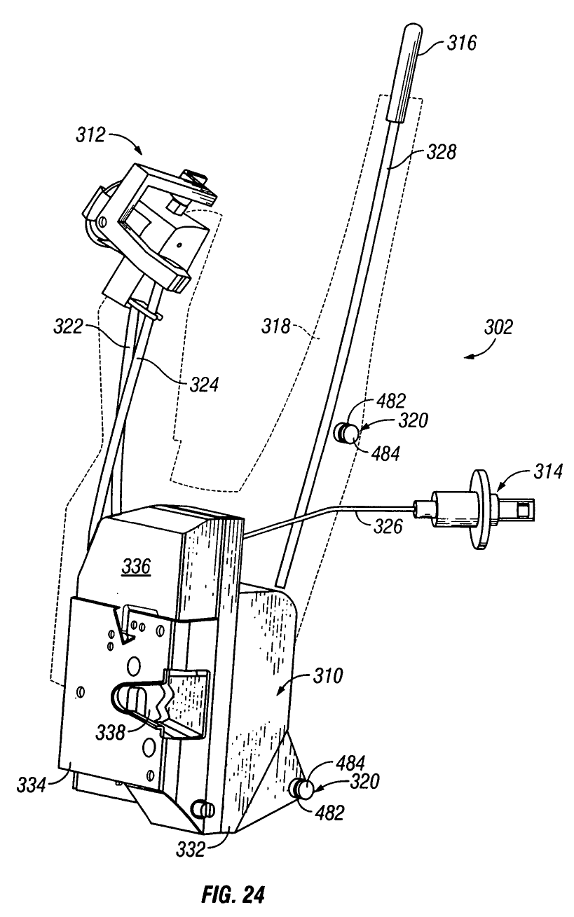

With reference also to FIG. 24, the latch assembly 302 of the illustrated embodiment includes cables 322, 324, 326, 328 between the interface members 312, 314 and the latch 310, and the sill button 316 and the latch 310. In the exemplary illustrated embodiment, an outside door lock cable 322 and an outside door release cable 324 extend between the outside interface member 312 and the latch 310, an inside door release cable 326 extends between the inside interface member 314 and the latch 310, and an inside door lock cable 328 extends between the sill button 316 and the latch 310. In some embodiments, the cables 322, 324, 326, 328 are Bowden cables which are capable of transferring tension and compression forces.

It will be appreciated by those skilled in the art that other types of linkages or combinations of other types of linkage elements and cables can be used instead of an all-cable system. For example, a substitute which can be made for one or more of the cables is another type of mechanical linkage such as a rod or bar. In such an arrangement, the rod can be used, for example, to connect the outside interface member 312 to the latch 310 instead of using the outside door lock cable 322. It will, however, be appreciated by those skilled in the art that the use of cables can substantially enhance the level of security afforded by the door latch assembly 300 of the present invention, since such cables are typically less susceptible to jimmying by a thief using a “slim jim.”

Referring to FIGS. 23 and 24, the bracket 318 can include an open end 330 that receives a portion of the latch 310. The open end 330 is sized to compress around the outside of the latch 310 to secure the bracket 318 and the latch 310 together. The interface member 312 can also be connected to the bracket 318 in this manner. However, one of ordinary skill in the art will appreciate that the attachment of the bracket 318 to the other components can be accomplished in many other ways. For example, the bracket 318 can be attached to the latch 310 and/or to the interface member 312 by the use of screws, nails, bolts, rivets and other conventional fasteners, glue, adhesives, snap-fits, inter-engaging members, and the like, and need not necessarily receive the latch 310 or interface member 312 for connection as just described.

The bracket 318 can be used to properly space the outside interface member 312 relative to the latch 310 and/or to properly space the sill button 316 relative to the latch 310. Although the brackets 318 can be made of any rigid or substantially rigid material such as metal, plastic, and the like, the bracket 318 can be made from a resilient and flexible material such as rubber or urethane so that the bracket 318 can be slightly bent or otherwise distorted to enable the bracket 318 and components 310, 312, 316 connected thereto to be more easily installed within a door and to avoid interference with a door frame during assembly. In addition, the material of the bracket 318 allows the bracket 318 to return to a desired relative position after the bracket 318 has been bent or otherwise distorted during installation. In other embodiments, the bracket 318 can be differently shaped to correspond to different vehicle door configurations. Accordingly, the bracket 318 may have any shape (e.g., any number and type of bends and curves) in which the bracket 318 is arranged and configured in accordance with a particular vehicle door configuration as well as to accommodate the various components to be assembled into the vehicle door.

In a modification of the bracket 318, an additional segment of the bracket 318 (or an entirely different bracket) can extend between the inside interface member 314 and the latch 310. The bracket 318 can be used to properly space the inside interface member 314 relative to the latch 310. Again, in other embodiments, the shape of the bracket 318 can differ to correspond to different door configurations. In addition, the bracket 318 can have any shape (e.g., a plurality of bends and curves contained therein) arranged and configured in accordance with the particular vehicle door configuration as well as to accommodate the various components to be assembled into the vehicle door.

The illustrated bracket 318 can enclose any one or more of the cables 322, 324, 328 within the bracket 318 to act as a shield member restricting access to the cables 322, 324, 328. This serves to further deter manipulation of the latch assembly 302 by those attempting to illegally gain access to a vehicle with the use of a “slim jim” or other type of equipment. In other embodiments, the bracket 318 does not completely enclose the cables 322, 324, 328, but merely restricts access along a portion of the cables 322, 324, 328 along the length of the cables 322, 324, 328. For example, the bracket 318 can be a channel open along one side along a substantial portion or all of the length of one or more of the cables 322, 324, 328, or the bracket 318 can be a plate restricting access from one or more sides along a substantial portion or all of the length of one or more cables 322, 324, 328. In short, the bracket 318 can have any shape desired, and in some embodiments at least extends from the latch 310 to the outside interface member 314 and/or the sill button 316 for shielding some part or all of at least one cable 322, 324 328 connected to the latch 310.

Referring now to FIGS. 24 and 25 and additional embodiment of a door latch 310 is illustrated. The door latch 310 can have a front cover 332, a rear mounting plate 334, and a housing 336 which together enclose the internal elements and mechanisms of the door latch 310. The rear mounting plate 334 can have a plurality of apertures (e.g., threaded apertures) which can be utilized to secure the door latch 310 to the structural framework of a vehicle door.

The door latch 310 operates to secure the vehicle door by releasably engaging and retaining a striker (not shown) mounted on a vehicle body. The exemplary illustrated door latch 310 utilizes a ratchet 338 (also known as a fork bolt) rotatably mounted within the housing 336. In this exemplary illustrated embodiment, the door latch 310, like the door latch described in the incorporated by reference patent application, has two control elements located therein, which are described in the above-incorporated by reference U.S. patent application Ser. No. 09/408,993.

Two of the cables 324, 326 attached to the illustrated door latch 310 are actuated by the outside door handle assembly 304 and the inside door handle assembly 308, respectively. More specifically, the outside door release cable 324 can be secured to the housing 336 and/or front cover 332, and can have a cable wire contained therein. The end of the cable wire can be attached to a control element within the latch 310. Similarly, an inside door release cable 326 can be secured to the housing 336 and/or front cover 332, and can have a cable wire contained therein. The end of the cable wire can be connected to another control element within the latch 310.

In some embodiments, the outside door lock cable 322 is connected to the front cover 332, and can contains a cable wire. Also, in some embodiments, the inside door lock cable 328 is connected to the front cover 332 and/or housing 336, and contains a cable wire. In the embodiment illustrated in FIGS. 23-25, the outside door lock cable 322 and the inside door lock cable 328 are both used to lock a control element of the door latch 310. When this control element is locked, and the outside door release cable 324 is pulled, the door latch 310 will not unlatch. When this control element is unlocked, and the outside door release cable 324 is pulled, the door latch 310 will unlatch. For more complete understanding of the operation of the exemplary door latch 310, the reader is referred to the above-incorporated by reference U.S. patent application Ser. No. 09/408,993. In the illustrated embodiment, the control element to which the inside door release cable 326 is connected is never locked (although it will be appreciated by those skilled in the art that it can be locked if the inside door lock cable 328 was connected to it in addition to the other control element).

With reference to the exemplary embodiment of FIGS. 23-25, and with particular reference to FIG. 24, the sill button 316 can be coupled to the latch 310 through the inside door lock cable 328 as described above. Pulling the sill button 316 from the interior side of a door frame can therefore pull a cable wire from the end of the inside door lock cable 328, unlocking the door latch 310. Similarly, pushing on the sill button 316 can push the cable wire back into the inside door lock cable 328, locking the door latch 310. Of course, other types of cable manipulation can correspond to locking, unlocking, and handle actuation operations as desired.

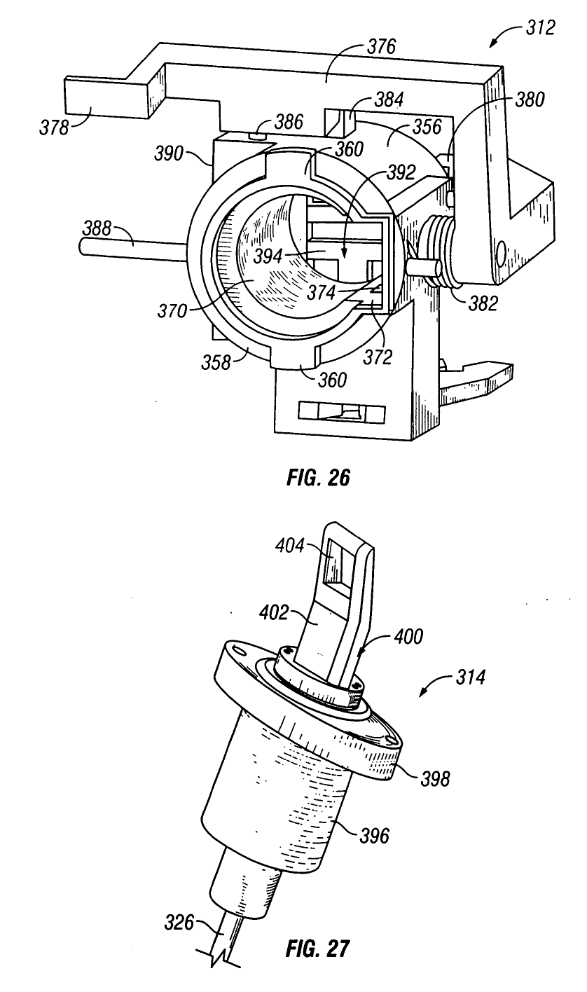

Referring now to FIG. 26, an outside interface member 312 according to the second illustrated embodiment of the present invention is shown. The outside interface member 312 can operate to: (i) provide a mounting location for the outside door lock 306; (ii) provide a coupling mechanism, or linkage, for interfacing rotary motion of the cylinder lock in the outside door lock 306 to linear motion (or a different motion) in the outside door lock cable 322; and/or (iii) provide a coupling mechanism, or linkage, for interfacing movement of the outside door handle assembly 304 to linear motion (or a different motion) in the outside door release cable 324.

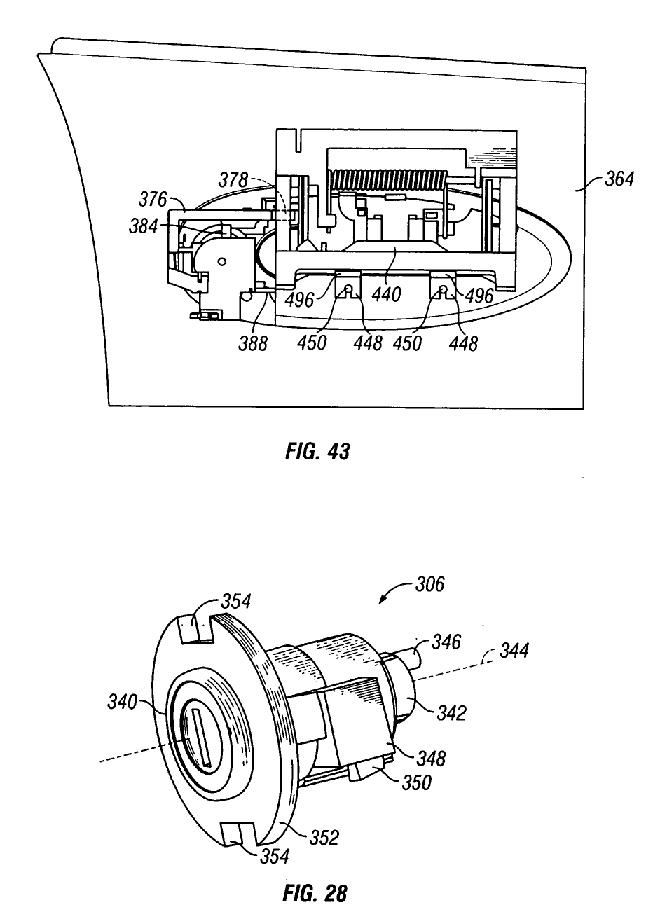

Referring next to FIG. 28, an outside door lock 306 is illustrated. The outside door lock 306 illustrated is a cylinder-type lock having a proximal end 340 into which a key (not shown) can be inserted. If the correct key is inserted into the outside door lock 306 and turned, a projection 342 located at the distal end of the outside door lock 306 will turn about a longitudinal axis 344 of the door lock 306. Located on one side of the projection 342 is a pin 346 or other element that extends from the distal end of the projection 342 and rotates with the projection 342 about the axis 344 when the correct key is inserted into the outside door lock 306 and turned. In some embodiments, it is the motion of this pin 346 (or other extension) that transfers motion of the door lock 306 in its unlocked state to unlock the latch 310. However, other door lock designs can be adapted in other manners to provide a mechanical connection with the outside interface member 312 to perform this same function.

Located on one side of the outside door lock 306 is a large rectangular projection 348. The large projection 348 ensures the proper orientation of the outside door lock 306 when it is inserted into the outside interface member 312 (illustrated in FIG. 26), and can instead take any other shape mating with a similar shape in the outside interface member 312 for performing a similar function. Extending from a side of the large projection 348 is a spring-loaded tapered projection 350 which will be used to retain the outside door lock 306 in the outside interface member 312 when installed therein. The outside door lock 306 can also include a circular flange portion 352 around the proximal end 340. The flange portion 352 can include two notches 354 on opposite ends of the circular flange 352.

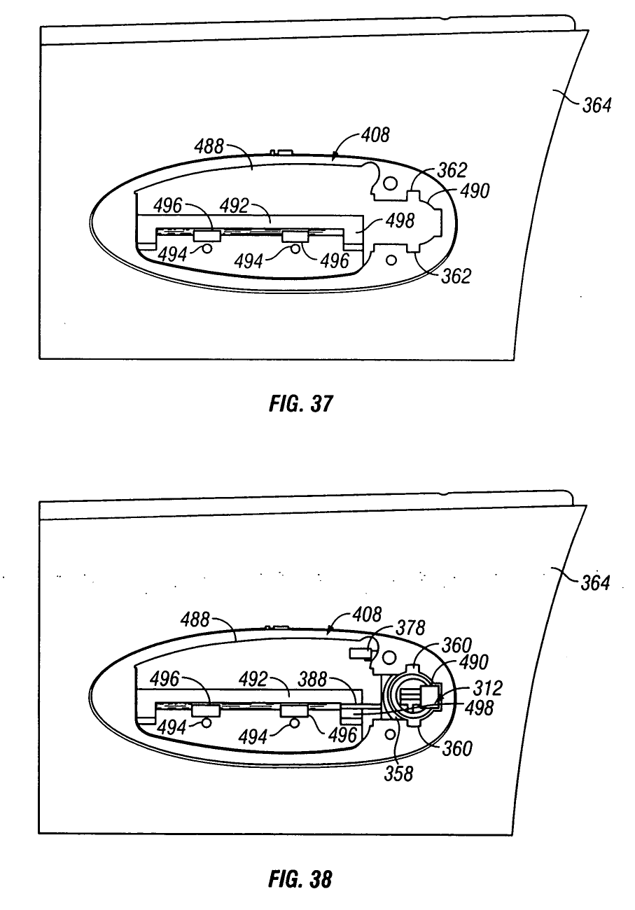

Referring back to FIG. 26, the outside interface member 312 in the exemplary illustrated embodiment includes a cylindrical housing member 356 which is hollow at one end to receive the outside door lock 306 therein. The end of the housing member 356 which has the opening therein can have a head portion 358 which has two raised tabs 360 located on opposite sides of the head portion 358. The raised tabs 360 can be configured to fit within cutout portions 362 in an outer skin 364 of a door frame 366 of a vehicle door 368 (shown in FIGS. 37-38) such that the raised tabs 360 correctly orient the outside interface member 312 relative to the door 368. In addition or instead, the raised tabs 360 can be received within the notches 354 of the outside door lock 306 such that the outside door lock 306 and the outside interface member 312 are correctly oriented relative to each other and the door frame 366. Other manners of orienting the outside interface member 312 with respect to the outside door lock 306 and the outside door lock 306 with respect to the door 368 are possible and are within the scope of the present invention.

The opening in the outside interface member 312 has a cylindrical opening portion 370 which is centrally located therein, with a rectangular opening portion 372 on one side thereof. A recess 374 is located on a portion of the rectangular opening 372 to engage the spring-loaded tapered projection 350 of the outside door lock 306 when installed in the outside interface member 312. The spring-loaded projection 350 maintains the outside door lock 306 within the outside interface member 312 and likewise resists the removal of the outside door lock 306 from the outside interface member 312. Other manners of maintaining the outside door lock 306 with the outside interface member 312 are possible and are within the scope of the present invention. For example, the projection 350 can be selectively actuable by the use of a master key in the lock. As another example, the projection can be positioned within the outside interface member 312 and movable within an opening located in the lock 306 when the lock is inserted into the outside interface member 312.

It will be appreciated by those skilled in the art that in many cases the outside door lock 306 is included in a set of identically-keyed locks for installation into the doors, the ignition switch, and another portion (e.g., trunk, tailgate, etc.) of the vehicle. Accordingly, in some cases the outside door lock 306 is not installed into the outside interface member 312 until the door latch assembly 300 is installed into a motor vehicle.

The outside interface member 312 also includes an actuator or linkage 376, that is pivotably coupled to the housing 356 and is movable to actuate a cable or other element extending to the latch 310. In other embodiments, the linkage 376 can move linearly with respect to the housing 356 or can move along a path that is defined in part by rotation and in part by linear movement. Although the linkage 376 can have any shape suitable for this purpose, the linkage 376 in the illustrated embodiment is generally L-shaped and includes one end having a tab 378 and a second end 380 connected to a cable wire that is located within the outside door release cable 324. A spring 382 can be positioned to bias the cable actuator 376 in an unactuated position. For example, and with reference to the exemplary embodiment in FIG. 26, the spring 382 can be positioned to bias the cable actuator 376 such that the second end 380 is biased downward and the tab 378 is biased in a rearward direction (as oriented in FIG. 26). The outside interface member 312 can include a permanent stop 384 which prevents the cable actuator 376 from being biased beyond the stop 384. The cable actuator 376 is illustrated as being in contact with a temporary stop 386 positioned in front of the permanent stop 384. The temporary stop 386 is integrally connected to a laterally extending pin 388. The laterally extending pin 388 is vertically movable within a slot 390 on the housing 356 such that downward movement of the laterally extending pin 388 moves the temporary stop 386 into the housing 356 and out of contact with the cable actuator 376, thereby causing the spring 382 to bias the cable actuator 376 back against the permanent stop 384.

Located in the back of the cylindrical opening portion 370 in the housing member 356 is a cable actuator 392. The outside door lock cable actuator 392 can include a U-shaped end 394 (similar to the embodiment illustrated in FIGS. 11 and 12), and an opposite end connected to a cable wire located inside the outside door lock cable 322. The pin 346 on the projection 342 of the outside door lock 306 will fit inside the interior of the U-shaped end 394 when the outside door lock 306 is installed into the outside interface member 312. Thus, it will be appreciated by those skilled in the art that when a key is placed into the outside door lock 306 and rotated, rotating the projection 342 and the pin 346, the pin 346 will actuate the cable actuator 392 and cause the cable wire to be moved inside the outside door lock cable 322. Other manners of transferring the rotational movement of the key into translational movement of the cable 322 are possible and within the scope of the present invention.

Referring to FIG. 27, the inside interface member 314 includes a cylindrical housing 396 including a mounting flange 398 and a cable actuator or linkage 400, movably received within the housing 396 through the flange 398. In other embodiments, the housing 396 can take any other shape desired, and can be mounted in any other suitable manner (e.g., by a bracket, by one or more bosses through which fasteners are passed, and the like). The cable actuator 400 can include a tab 402 having a aperture 404 (e.g., a rectangular aperture 404 as shown in FIG. 27 or an aperture having any other shape desired). The end of the tab 402 within the housing 396 is connected to a cable wire within the inside door release cable 326 such that movement of the tab 402 relative to the housing 396 moves the cable wire within the inside door release cable 326, thereby actuating the latch 310.

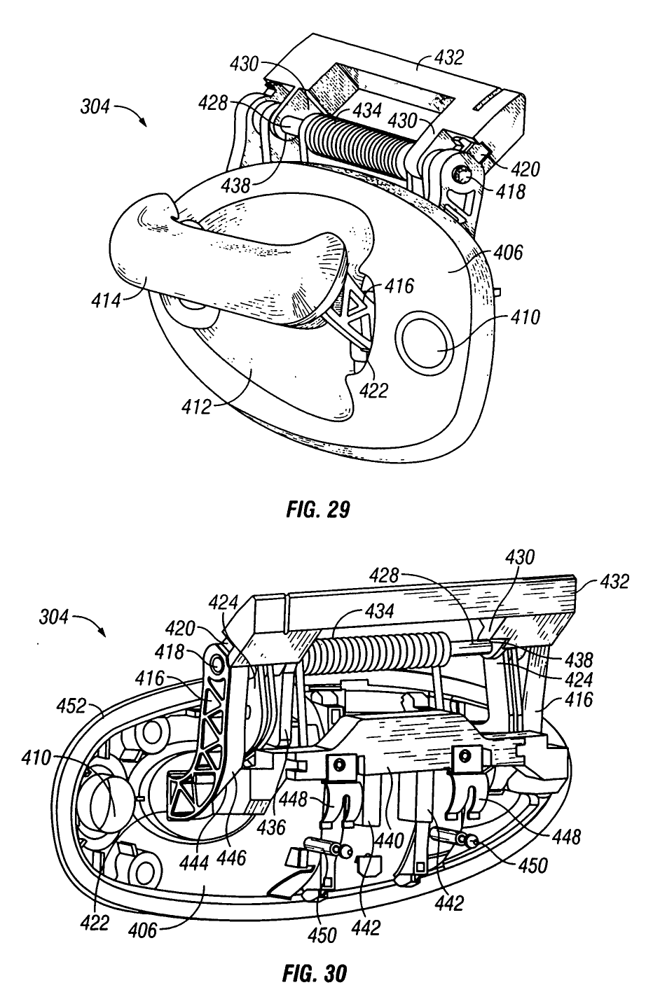

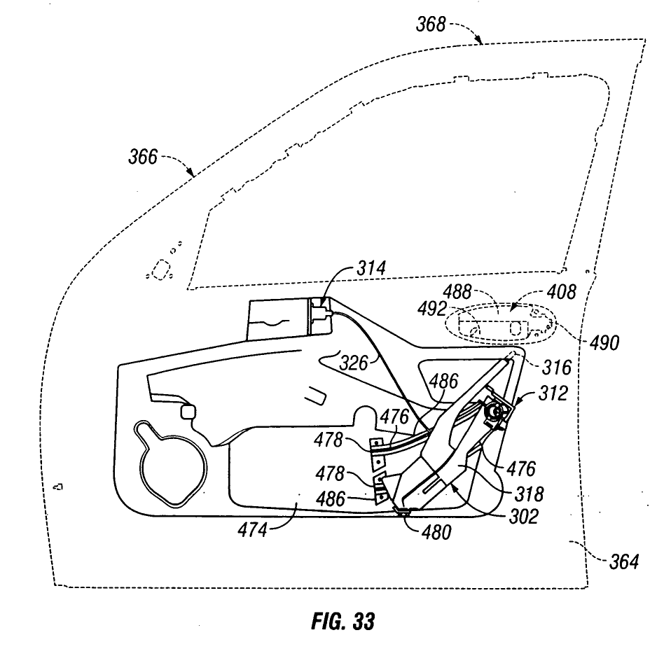

Referring next to FIGS. 29 and 30, the construction of an exemplary outside door handle assembly 304 according to the present invention is illustrated. In some embodiments, the various components of the outside door handle assembly 304 are assembled onto a housing member 406, which is of a size and configuration to fit partially into an opening 408 in the outer skin 364 of the structural framework 366 of the vehicle door 368 (shown by way of example in FIGS. 33 and 37). The outer periphery of the housing member 406 can be larger than the opening 408 in the outer skin 364 of the structural framework 366 of the vehicle door 368.

In some embodiments, the housing member 406 includes an aperture 410 for receiving the proximal end 340 of the outside door lock 306. This aperture 410 can be located anywhere on the housing member 406, and in the illustrated embodiment is located near one side of the housing member 406. The housing member 406 can also have a concave portion 412 for receiving an outside door handle 414 therein (e.g., in a flush manner when the outside door handle 414 is not actuated).

The illustrated outside door handle 414 has two support arms 416 located near opposite ends of the outside door handle 414, although any number of support arms 416 can be employed. Each support arm 416 can have an aperture 418 located near the end thereof remote from the point of attachment of the support arm 416 to the outside door handle 414. In some embodiments, the support arm 416 has an extension 420 projecting from the support arm 416 from the end thereof remote from the point of attachment of the support arm 416 to the outside door handle 414.

To facilitate connection of the door handle 414, the housing member 406 can have openings 422 (two openings 422 located near opposite ends of the concave portion 412 in the illustrated embodiment) to admit the support arms 416, respectively, therethrough. With continued reference to the illustrated exemplary embodiment of FIGS. 29 and 30, extending from the housing member 406 on the back side of the concave portion 412 immediately outside beside the openings are two handle mounting arms 424. The handle mounting arms 424 can have apertures (not shown), respectively, located near their ends which are remote from their point of attachment to the outside door handle housing member 406.

The illustrated exemplary mechanism used to mount the outside door handle assembly 304 is similar to the apparatus taught by U.S. Pat. No. 5,706,554, which has been incorporated herein by reference above. The outside door handle assembly described in U.S. Pat. No. 5,706,554 secures the door handle assembly to the door by actuating the handle from an unactuated position to an actuated position. It should be noted that the present invention can also be used with an outside door handle that is secured by actuating the handle from an actuated position to an unactuated position, such as described in U.S. Pat. No. 6,594,861, the entire contents of which is incorporated by reference herein. In addition, other embodiments can utilize outside door handles that are securable by other methods.

A pin 428 extends through the apertures 418 of the support arms 416 and the apertures of the handle mounting arms 424 and through mounting flanges 430 of a counter balance 432. Also mounted on the pin 428 is a spring 434, which bears against a depending arm 436 of the counter balance 432 and the inside surface of the housing member 406 (or element affixed and/or extending therefrom), and operates to bias the outside door handle 414 in its de-actuated position with respect to the housing member 406.

Where employed, the pin 428 in some embodiments extends sequentially through the aperture 418 in the support arm 416, the aperture in the handle mounting arm 424, an aperture 438 in the mounting flange 430, the spring 434, the aperture 438 in the mounting flange 430, the aperture in the handle mounting arm 424, and the aperture 418 in the support arm 416. In some embodiments, the pin 428 has an interference fit with one or both of the apertures in the handle mounting arms 424, respectively, although other ways of retaining the pin 428 in place are readily apparent to those skilled in the art.

The outside door handle assembly 304 includes a slide 440 that is slidably coupled to the housing member 406 in any manner, such as by and along ribs 442 of the housing member 406. The slidable connection between the slide 440 and the housing member 406 can be oriented to permit the slide 440 to move in any desired direction and amount with respect to the housing member 406. In the illustrated embodiment for example, the slide 440 is movable along the ribs 442 between a first position where the slide is approximately located on the upper half of the housing member 406 and a second position along the ribs 442 adjacent a lower portion of the housing member 406. The slide 440 can include angled surfaces 444 on each side of the slide 440 which contact cam surfaces 446 of the support arms 416 during initial de-actuation of the handle 414. The slide 440 also includes one or more fasteners (e.g., two clips 448 in the illustrated embodiment) which are aligned with a corresponding number of fasteners (e.g., retainer pins 450 in the illustrated embodiment) directly or indirectly connected to the housing member 406. Any other fastening elements connectable by sliding movement of the slide 440 can instead be employed as desired.

In some embodiments, the outside door handle assembly 304 is shipped in the actuated position (shown in FIGS. 29 and 30). When the outside door handle 414 is moved to the de-actuated position, the cams 446 move against the angled surfaces 444 of the slide 440, thereby moving the slide 440 from the first position to the second position and engaging the clips 448 with the corresponding retaining pins 450. This process is utilized to assemble and secure the outside door handle assembly 304 to the door frame 366 of the vehicle door 368, and will be described in more detail below.

Finally, a mounting gasket 452 can be placed on the inside of the housing member 406 around the perimeter thereof. The mounting gasket 452 can be located intermediate the inside of the housing member 406 and the outer surface 364 of the structural framework 366 of the vehicle door 368 when the outside door handle assembly 304 is installed on the structural framework 366 of the vehicle door 368. The outside door handle housing member 406 and/or outside door handle 414 can be of any material desired, including without limitation metal, plastic, composites, and the like.

While the outside door handle illustrated herein is of the paddle type, it will be readily appreciated to those skilled in the art that other types of door handles can instead by employed (e.g., a pull strap type door handle) in conjunction with the lock and latch system of the present invention. In addition, either of these types of door handles can be mounted and pivot with respect either to an outside door handle housing member, to the outer skin or other portion of the structural framework of the vehicle door, or to the outside door lock and door handle interface member. In other embodiments, the door handle can be mounted for linear movement or movement that is partially defined by rotation and translation. Such changes and substitutions will be readily apparent to one skilled in the art once the principles of the present invention have been made known to that person.

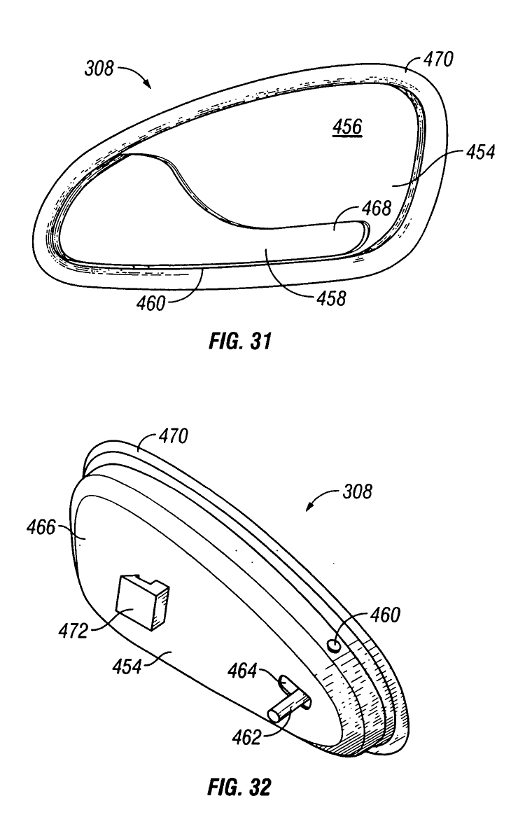

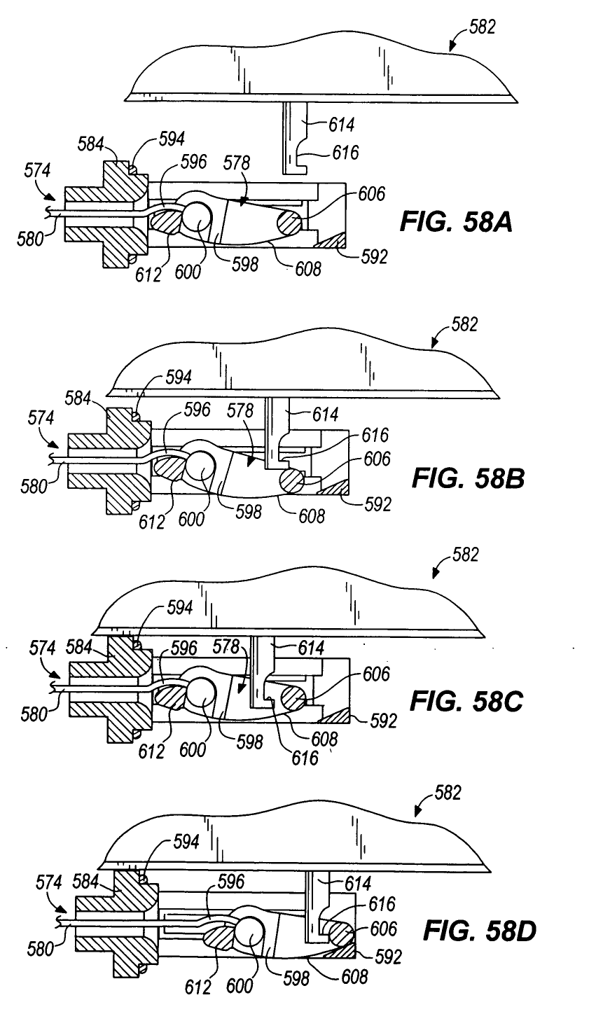

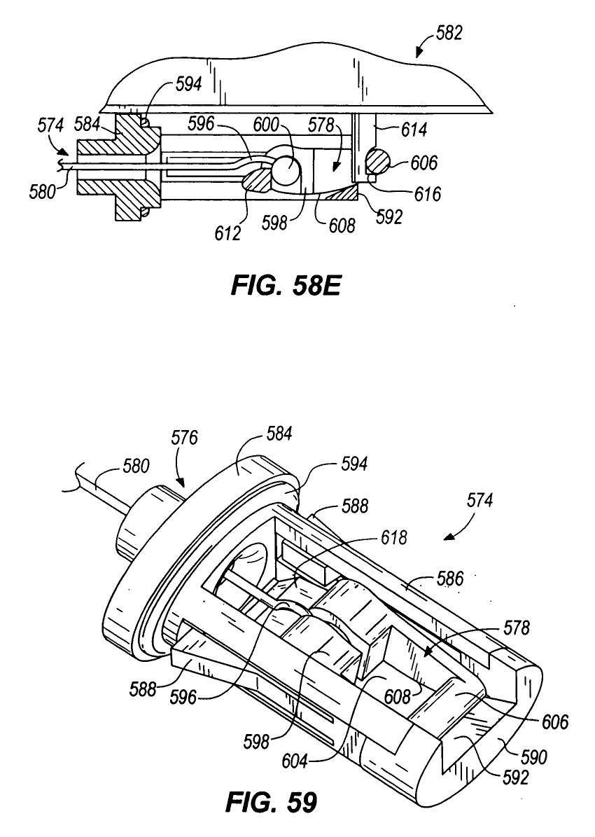

Referring next to FIGS. 31 and 32, an inside door handle assembly 308 according to an exemplary embodiment of the present invention is illustrated for installation in the structural framework 366 of the vehicle door 368. The inside door handle assembly 308 has a housing 454, which can have a concave interior surface 456 for at least partially receiving an inside door handle 458. The inside door handle 458 can be pivotably coupled to the housing 454 on the interior side through a pivot pin 460. In some embodiments, the handle 458 also includes a projection 462 that extends through an aperture 464 in the housing such that the projection 462 extends outwardly from the exterior surface 466 of the housing 454. The aperture 464 can be shaped and sized (e.g., an elongated aperture 464) to permit the projection 462 to move within the aperture 464. In this regard, the projection 462 is movable to move with the handle 458 as the handle 458 is pivoted between the actuated and de-actuated positions. Actuating the illustrated inside door handle 458 is accomplished by pulling its unconnected end 468 outwardly from the base member 454, which pulls the cable wire from the end of the inside door release cable 326 (or otherwise actuates any other mechanical linkage to the latch 310 as described above). The connection of the pin 462 and the tab 402 through the aperture 404 is described in more detail below with reference to FIGS. 58A-D. The housing 454 can also include a flange 470 located on a front perimeter of the housing 454, and/or a clip 472 or other fastener located on the back side 466 of the housing 454.

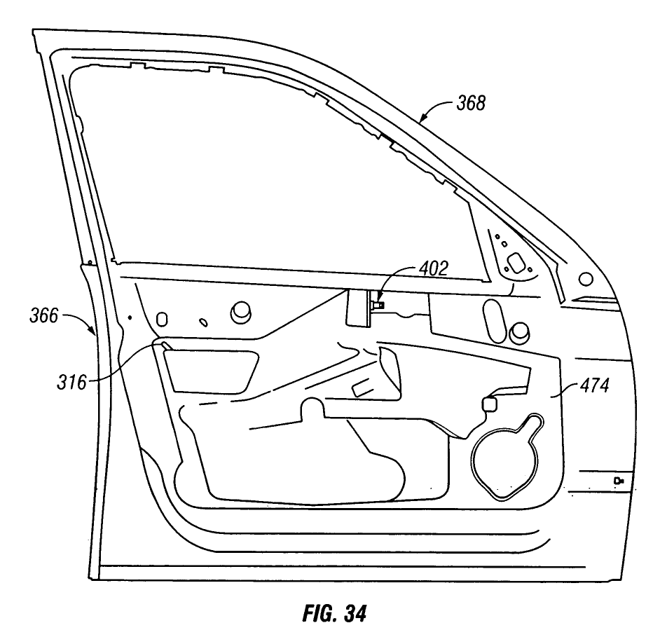

Referring to FIGS. 33 and 34, the structural framework 366 of an exemplary vehicle door 368 is illustrated from the outside in FIG. 33 and from the inside in FIG. 34. The structural framework 366 of the vehicle door 368 has an opening 408 in the outer skin 364 (best illustrated in FIGS. 33 and 37) into which the outside door handle assembly 304 and an outside door lock 306 can be received. The structural framework 366 of the vehicle door 368 also has the location at which the inside door handle assembly 308 can be positioned and the location at which the door latch 310 can be positioned.

The process of assembling the illustrated door latch assembly 300 to the door frame 366 of a vehicle door 368 is explained in detail with reference to FIGS. 33-45.

In some embodiments of the present invention, the latch assembly 302 is pre-assembled onto a carrier panel 474. The carrier panel 474 can be coupled in its entirety to the door frame 366 of the vehicle door 368, thereby accelerating the assembly of the latch assembly 302 to the door 368.

As illustrated in FIG. 33, in some embodiments the latch assembly 302 is pre-assembled to the carrier panel 474 by inserting each of the pins 320 of the latch assembly 302 into a respective channel 476, rail, track, or other guide of the carrier panel 474. The bottom ends 478 of the channels 476 are open such that the pins 320 of the latch assembly 302 can be received within the channels 476 to secure the latch 310 to the carrier panel 474. A stop or cradle 480, can be attached to the carrier panel 474 after the pins 320 are inserted into the channels 476 to prevent the latch 310 from moving downward, thereby ensuring that the pins 320 are maintained within the channels 476 during shipping. In the illustrated embodiment, the pins 320 include a shaft portion 482 and an enlarged head 484 on the distal end of the shaft 482 (see FIG. 25), and the channel 476 includes inwardly-projecting flanges 486 such that the enlarged head 484 is received within the channel 476 and the inwardly-projecting flanges 486 trap the enlarged head 484 to maintain the enlarged head 484 within the channel 476.

In other embodiments, the latch assembly 302 can be movably secured to the carrier panel 474 by integral slots in the carrier panel 474 in which projections on the latch assembly 302 ride. In yet another embodiment, the latch assembly 302 can include bearings, guides, rollers or the like that ride along rails or wires of the carrier panel 474. Other embodiments of the stop 480 can include projections that extend from the carrier panel 474 to limit movement of the latch assembly 302, one or more closed ends of the tracks, one or more stops placed along the track after the latch assembly 302 is inserted, and the like.

The inside interface member 314 can also be coupled to the carrier panel 474 by connecting the flange 398 to a carrier mounting location, or by connecting the housing 396 of the inside interface member 314 to the carrier panel 474 in any other manner as described in greater detail above. In the illustrated embodiment, the inside interface member 314 is connected to the carrier panel 474 such that the tab 402 extends through an aperture in the carrier panel 474 to the interior side of the carrier panel 474. It should be noted that it is not required for the inside interface member 314 to extend through an aperture in the carrier panel 474. In other embodiments, the tab 402 is accessible from the interior of the carrier panel 474 without extending through an aperture. For example, the inside interface member 314 and inside door release cable 326 can be entirely positioned on the interior side of the carrier panel 474.

After the latch assembly 302 is pre-assembled to the carrier panel 474 (where employed), the carrier panel 474 can be assembled to the door 368, as illustrated in FIG. 33. The latch assembly 302 is shown in a first position supported by the cradle 480. In the first position, the latch assembly 302 is oriented in a manner at least partially determined by the pins 320 received within the channels 476. The latch assembly 302 is installed on the carrier panel 474 by positioning the pins 320 within the ends of the channels 476 while the sill button 316 is positioned within an aperture located on the carrier panel 474. FIG. 34 illustrates the carrier panel 474 and the latch assembly 302 in the first position from the interior side of the carrier panel 474. As described above, the tab 402 is accessible from the interior side of the carrier panel 474. Additionally, the sill button 316 is accessible from the interior side of the carrier panel 474. The position of the sill button 316 in the illustrated embodiment is maintained by the bracket 318. The sill button 316 extends through the aperture in the carrier panel in its first position (FIGS. 33 and 34). By this relationship, the carrier panel 474 adjacent the sill button 316 assists in keeping the latch assembly 302 in place on the carrier panel 474 to act as a third capture point for the latch assembly. The other capture points are the pins 320 received within the channels 476.

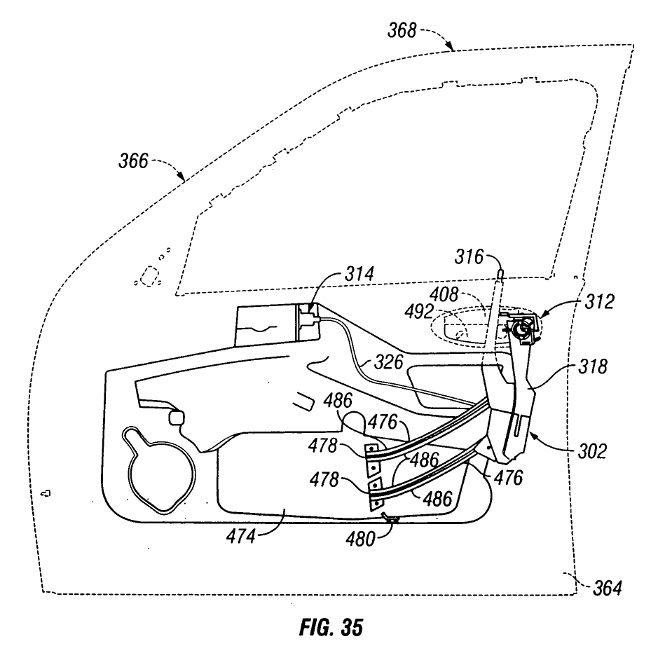

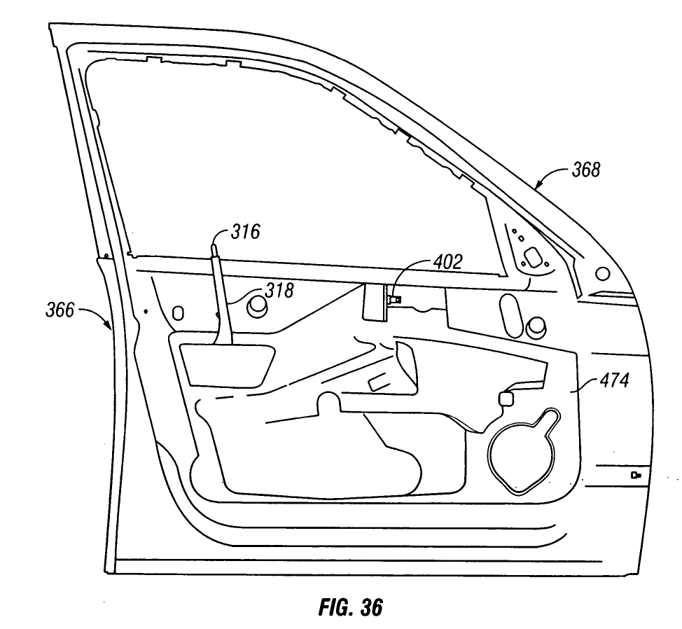

FIG. 35 illustrates the latch assembly 302 shown in FIGS. 33 and 34 in a second position where the mounting plate 334 of the latch 310 (see FIGS. 24 and 25) can be fastened to the door 368 (e.g., the shut face of the door in the illustrated embodiment). In this regard, the latch 310 is moved from the first position (FIGS. 33 and 34) to the second position (FIGS. 35 and 36) by sliding the pins 320 along the channels 476. The channel arrangement serves to move the latch assembly 302 to a defined position and to correctly orient the latch assembly 302 in each position. With reference to FIGS. 34 and 35, the latch assembly 302 can, in some embodiments, be moved from the first to the second position by grabbing the sill button 316 and pulling the sill button 316 to move the latch assembly 302. Pulling on the sill button 316 moves the latch assembly 302 to the second position along the path defined by the channels 474 so that the operator can fasten the latch 310 to the shut face of the door 368.

FIG. 37 illustrates the opening 408 in the outer panel 364, or skin, of the door frame 366. In some embodiments, the opening 408 is configured to include a main opening portion 488 and a secondary opening portion 490 (which in some embodiments can be defined by different portions of the same opening). In the illustrated embodiment by way of example only, the secondary opening portion 490 includes two rectangular cutouts 362 on opposite ends. Also in the illustrated embodiment, the outer panel 364 includes a recessed portion 492 that extends approximately to the middle of the main opening portion 488. The recessed portion 492 can include two apertures 494 and two slots 496 for connection of the outside door handle assembly 304 (although other types and numbers of openings in the recessed portion 492 are possible depending at least partially upon the types of fasteners employed on the outside door handle assembly 304). The recessed portion 492 can also include a depression 498 on the side of the recessed portion 492 that is closest to the secondary opening portion 490.

As illustrated in FIG. 38, after the latch assembly 302 has been moved and fastened into the second position, the bracket 318 orients (and in some cases, due to the resiliently deformable material of the bracket 318, biases) the outside interface member 312 adjacent to the secondary opening portion 490 such that the outside interface member 312 is accessible from the exterior side of the outer panel 364. Next, an assembler can manipulate the outside interface member 312 such that the raised tabs 360 are positioned within the rectangular cutouts 362 of the secondary opening portion 490 (in those cases employing such a mating arrangement), the laterally extending pin 388 is positioned within the depression 498, and the tab 378 extends into the main opening portion 488.

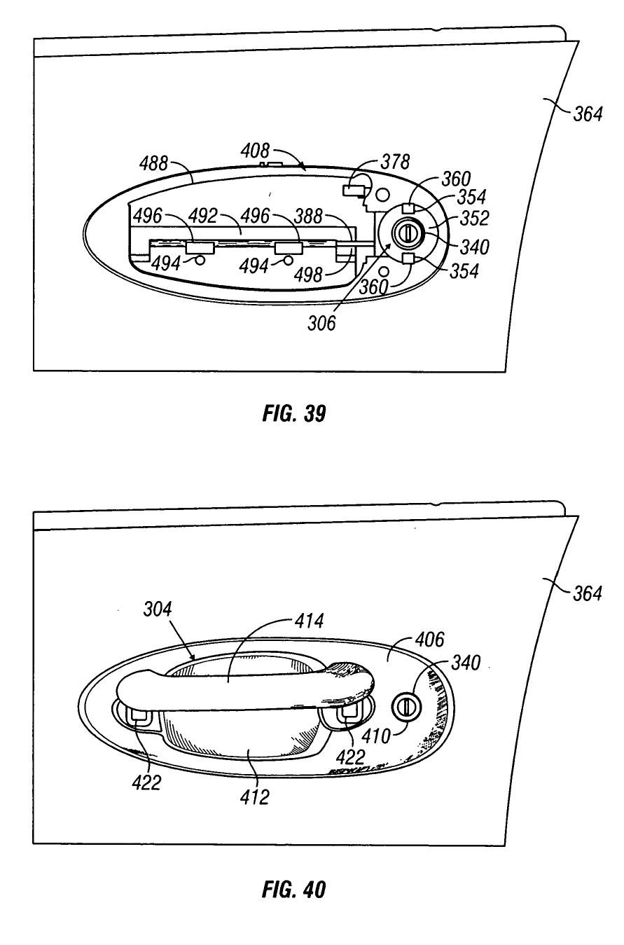

Referring to FIG. 39, the outside door lock 306 can be inserted through the secondary opening portion 490 and into the cylindrical opening 370 of the outside interface member 312. In some embodiments, the outside door lock 306 is inserted until the spring-biased tapered projection 350 extends into the recess 374 within the rectangular cavity 372 of the outside interface member 312. When the projection 350 extends, the outside door lock 306 is secured within the housing 356. As explained above, the projection 350 can also be actuated to the secured position by the use of a master key. In other embodiments, the projection 350 can be located on the outer interface member 312 and move within a recess in the outside door lock 306. After insertion of the outside door lock 306, the cutouts 354 of the flange 352 receive the raised tabs 360 of the outside interface member 312 (in those cases employing such a mating arrangement). Insertion of the outside door lock 306 can also serve to secure the outside door lock 306 and the outside interface member 312 to the outer panel 364 of the door 368. Specifically, by inserting the outside door lock 306, a portion of the outer panel 364 surrounding the secondary opening portion 490 can be trapped between the head portion 358 of the outside interface member 312 and the flange 352.

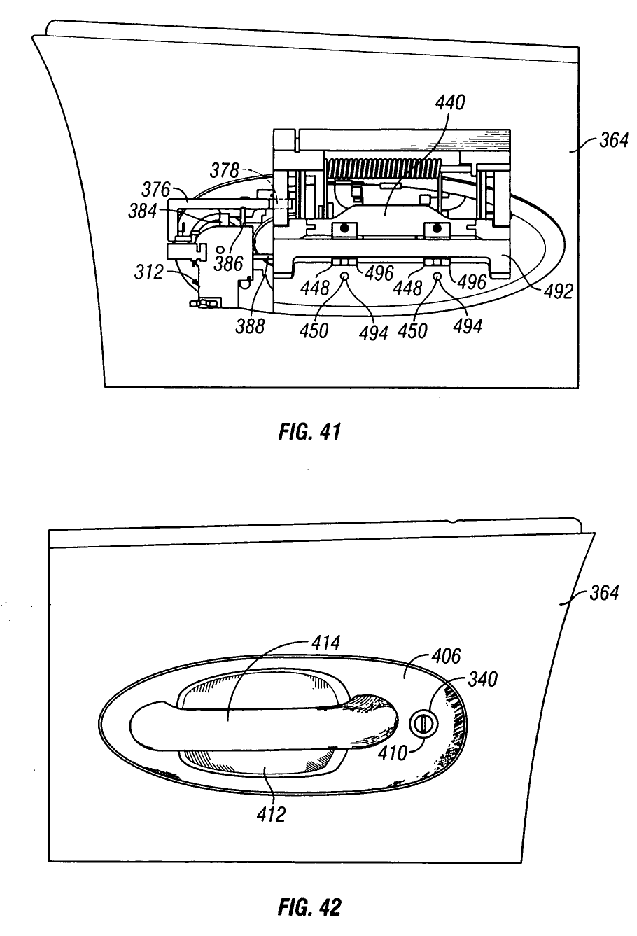

FIGS. 40 and 41 illustrate the insertion of the outside door handle assembly 304 into the main opening portion 488. As shown in FIG. 40, in some embodiments the outside door handle assembly 304 is inserted in the actuated position such that the housing member 406 seals against the outer panel 364 of the door 368 to cover the opening 408. The proximate end 340 of the outside door lock 306 partially extends and is accessible through the aperture 410. In other embodiments, the outside door handle assembly 304 does not cover an area surrounding the outside door lock 306.

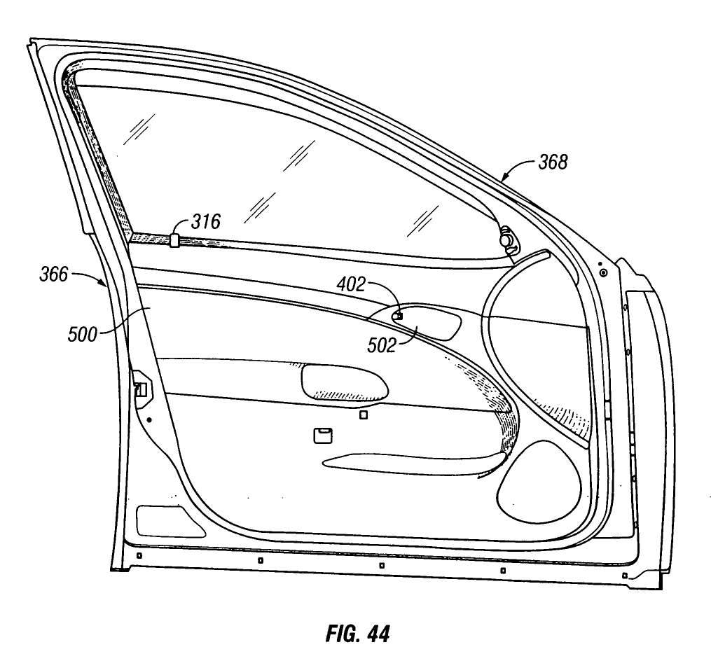

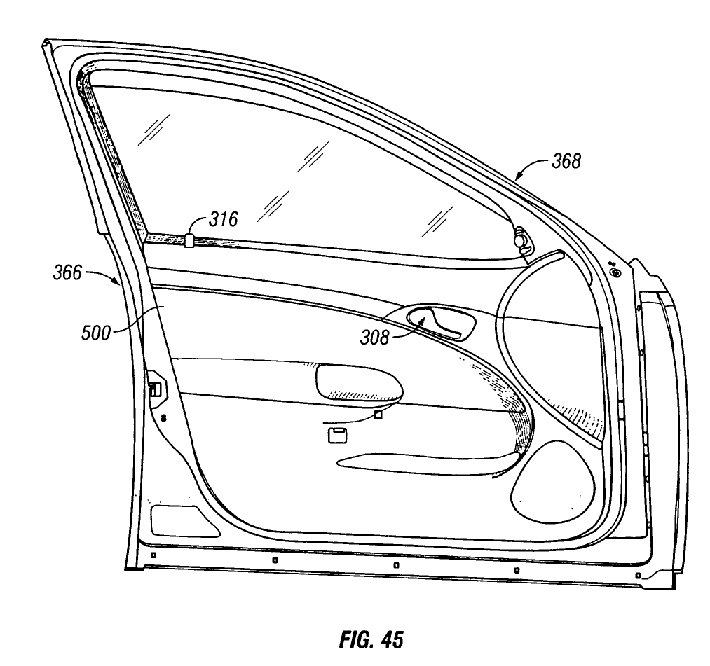

As best shown in FIG. 41, the illustrated outside door handle assembly 304 is positioned such that the retaining pins 450 extend through the apertures 494, the clips 448 are in retracted positions with respect to the slots 496, and the tab 378 is positioned between the housing member 406 and the support arm 416 near the outside interface member 312. FIGS. 42 and 43 illustrate the de-actuation of the outside door handle 414 of FIGS. 29 and 30 to secure the outside door handle assembly 304 to the outer panel 364 of the door 368. As illustrated in FIG. 42, the outside door handle 414 is moved from the raised actuated position to the lowered de-actuated position. FIG. 43 better illustrates the securing effect of this movement. As shown in FIG. 43, movement of the outside door handle 414 moves the cams 446 (FIG. 30) against the angled surfaces 444 (FIG. 30) of the slide 440, thereby moving the slide 440 downward. The downward movement of the slide 440 moves the clips 448 through the slots 496 until they engage the engagement pins 450. In addition, movement of the slide 440 moves the laterally extending pin 388 downward, which, as explained above, removes the temporary stop 386 from the cable actuator 376. Without contact between the temporary stop 386, the cable actuator 376 is free to move against the permanent stop 384 under the bias of the spring 382.

Once the outside door handle 414 has been de-actuated, the slide 440 remains in the lowered, secured position. In addition, further actuation of the outside door handle 414 will bring the support arm 416 into contact with the tab 378 (see FIGS. 26, 29, and 30), which will pivot the L-shaped linkage 376 to actuate the outside door release cable 324. When the handle 414 is de-actuated, the linkage 376 is biased to return to the position against the permanent stop 384.

FIG. 44 illustrates a trim panel 500 attached to the interior of the door frame 366, covering the carrier panel 474. The trim panel 500 can include an opening 502 for the inside door handle assembly 308. The tab 402 of the cable actuator 392 extends adjacent the opening 502 and is accessible through the opening 502 from the interior side of the trim panel 500.

With reference to FIG. 45, the inside door handle assembly 308 is inserted into the opening 502 in the trim panel 500. As the inside door handle assembly 308 is inserted into the opening 502, the projection 462 extends at least partially into the rectangular aperture 404 of the tab 402 and the clip 472 extends around a portion of the carrier panel 474. It will be appreciated that other manners of connecting the inside door handle assembly 308 to the inside interface member 314 by insertion of the inside door handle assembly 308 are possible, each of which falls within the spirit and scope of the present invention. Similarly, the clip 472 (if employed) need not necessarily engage the carrier panel 474, and can instead be connected to any part of the door (being adapted for such engagement as necessary). The housing 454 can be dimensioned to create a press-fit within the opening 502 such that the press-fit, the clip 472, and the projection 462 act together to maintain the inside door handle 458 within the opening 502.

In other embodiments, a carrier panel 474 is not used to pre-assemble with the latch assembly 302. Instead, the latch assembly 302 can be inserted directly into the cavity of a vehicle door 368 through apertures provided on the inner panel of the door 368. In this embodiment, an assembler can move the latch assembly 302 into the cavity through the aperture, and can position the latch 310 against the shut face of the door. By this motion, the sill button 316 can be positioned to extend out from the cavity and/or the outside interface member 312 can be positioned with respect to the opening 408. The assembler can then couple the inside interface member 314 to the inner panel of the door such that the inside interface member 314 is accessible from the interior side of the inner panel.

It will therefore be appreciated from the above detailed description of the embodiments of the present invention that a locking and latching system of modular construction is taught, in which the components of the system can be pre-assembled prior to their installation into the structural framework of a vehicle door. The modular construction of the lock and latch system can include outside and inside door handles, outside and inside locks, the door latch itself, as well as linkages between these components. In some embodiments, the modular components of the present invention facilitate the assembly process by being of a design which simplifies the process of installing them into the structural framework of a vehicle door without requiring the use of specialized tools, thereby reducing labor costs associated with assembly. Some embodiments of the lock and latch system can substantially enhance the security of a vehicle by providing an enhanced level of resistance to manipulation by jimmying with a “slim jim” or similar tool of the type commonly used by car thieves.

The lock and latch system can include an outside door handle as a separate modular component, thereby allowing outside door handles to be manufactured in a variety of colors to match exterior vehicle paint colors while allowing the other modular components of the system to be of a single type and color. The pre-assembled nature of the modular components in some embodiments of the present invention can eliminate the requirement for adjustments to be made during the assembly of the components of the lock and latch system into the structural framework of a vehicle door, thereby further minimizing assembly costs while simultaneously enhancing vehicle quality. The modular components of the lock and latch system of the present invention can be adaptable for uses on a variety of different vehicles by merely switching outside door handles and providing different size linkages between the various modular components.

The lock and latch system can be of a construction which is both durable and long lasting, and which requires little or no maintenance to be provided by the user throughout its operating lifetime. The lock and latch system of the present invention can also be of inexpensive construction to enhance its market appeal and to thereby afford it the broadest possible market.

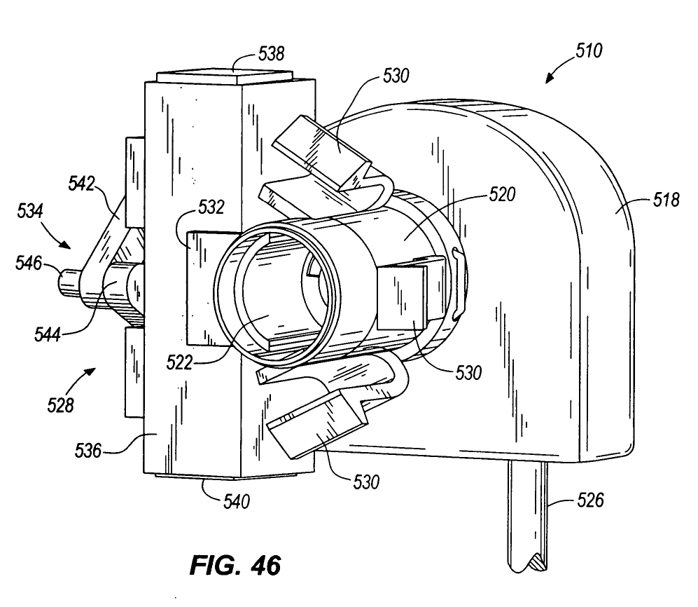

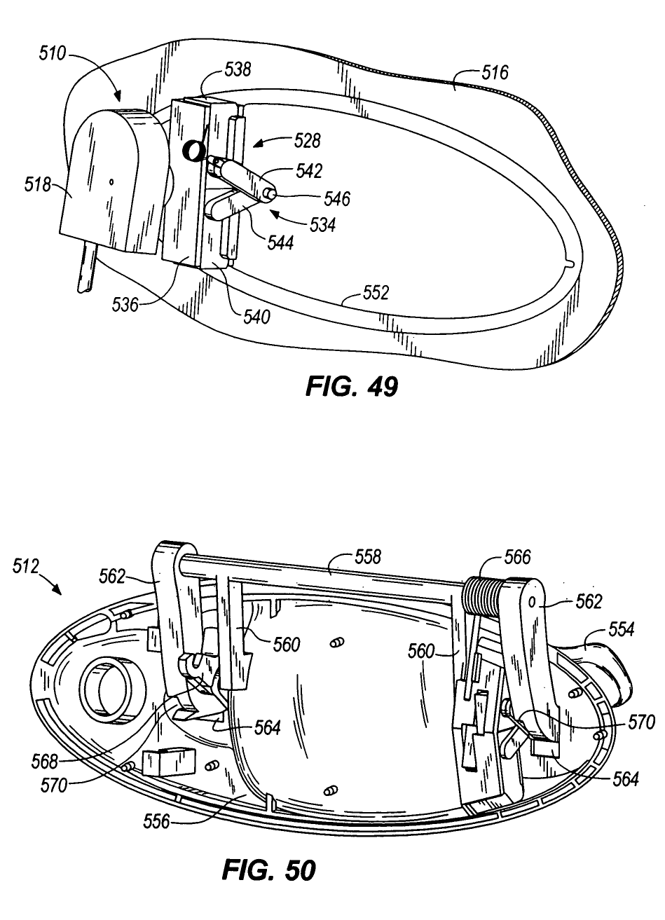

An additional embodiment of the outside interface member 510 and the outside door handle assembly 512 are illustrated in FIGS. 46-52. This embodiment illustrates another method of securing the outside door handle assembly 512 and outside interface member 510 to the outer skin of the door 516. As shown in FIG. 46, the outside interface member 510 includes a housing 518 and a cylindrical housing member 520 that extends outwardly from the housing 518. The cylindrical housing member 520 includes a cylindrical opening 522 that is configured to receive an outside door lock assembly 524 (FIG. 48). An outside door lock cable 526 is coupled to the outside interface member 510 and to a door latch (not shown) such that actuation of the outside door lock assembly 524 received within the cylindrical opening 522 actuates the outside door lock cable 526 to lock and unlock the door latch.

The outside interface member 510 includes a securing assembly 528 and three resiliently-biased tabs 530. The tabs 530 are located around one side of the cylindrical housing 520 and the securing assembly 528 is located on the opposite side of the cylindrical housing 520. A retaining flange 532 extends from the cylindrical housing member 520 and is spaced to form a gap between itself and the securing assembly 528. The securing assembly 528, the tabs 530, and the retaining flange 532 couple the outside interface member 510 to the outer skin of the door 516 from the inside of the door 516 as will be described in greater detail below.

The securing assembly 528 includes a securing linkage 534 movably retained within a block guide 536 defined by a portion of the housing 518. The securing linkage 534 includes an upper securing block 538 and a lower securing block 540 that are slidably coupled within the block guide 536. The securing linkage 534 also includes an upper linkage 542 pivotally coupled to a lower linkage 544 at their first ends. The opposite end of the upper linkage 542 is pivotally coupled to the upper block 538 and the opposite end of the lower linkage 544 is pivotally coupled to the lower block 540. The upper linkage 542 includes a boss 546 adjacent the first end of the upper linkage 542 and extending in a direction opposite to the housing 518 of the outside interface member 510. The upper securing block 538 can be extended upwardly and the lower securing block 540 can be extended downwardly by moving the boss 546 in a first, or securing direction toward the interior of the door 516. In this embodiment, assembly of the outside interface member 510 to the door 516 begins with the securing linkage 534 in the unsecured position (as shown in FIG. 46) with the securing blocks 538, 540 retracted within the block guide 536.

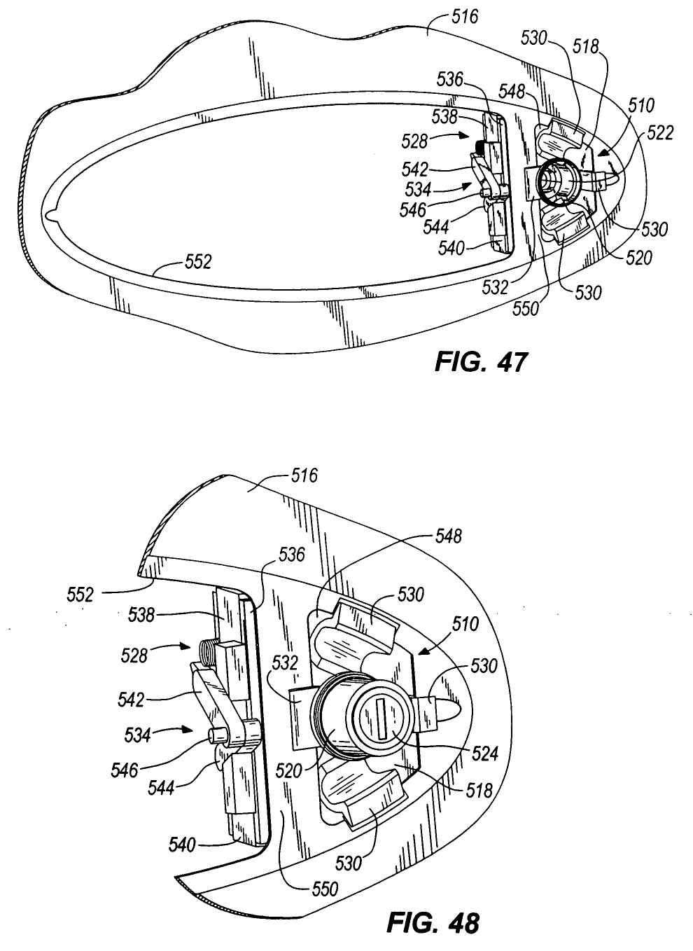

The assembly of the outside interface member 510 is described below with reference to FIGS. 47-49. The outside interface member 510 is inserted through a secondary opening 548 in the outer skin of the door 516 from the interior side of the door 516. As it is inserted, the retaining flange 532 is positioned in front of a wall 550 that divides a main opening 552 and the secondary opening 548. The outside interface member 510 is then rotated causing the resiliently-biased tabs 530 to enter the secondary opening 548. Initially, the tabs 530 are bent inwardly toward the cylindrical housing member 520. As the outside interface member 510 continues to pivot about the flange 532, the undercuts of the tabs 530 extend past the outer skin of the door 516 causing the tabs 530 to snap outwardly such that the outside interface member 510 is secured within the secondary opening 548 with the flange 532 and the tabs 530. As shown in FIG. 48, the door lock assembly 524 is received within the cylindrical opening 522.

The outside door handle assembly 512, illustrated in FIGS. 50-52, includes an outside door handle 554 pivotally coupled to the outside door handle housing 556. The outside door handle assembly 512 includes a shaft 558 coupled to two handle mounting arms 560 that are connected to the door handle housing 556. The outside door handle 554 is pivotally coupled to the shaft 538 through two support arms 562 that extend through apertures 564 in the housing 556. In this embodiment, the outside door handle 554 is shipped and installed in the actuated condition. A spring 566 is configured and coupled to bias the handle 554 in the deactuated position only after the handle 554 has initially been moved to the deactuated position from the actuated position. The outside door handle assembly 512 also includes a linkage having a hook member 568 that engages the outside door release cable (not shown) such that actuation of the handle 554 actuates the hook 568 and outside door release cable to release the door latch.

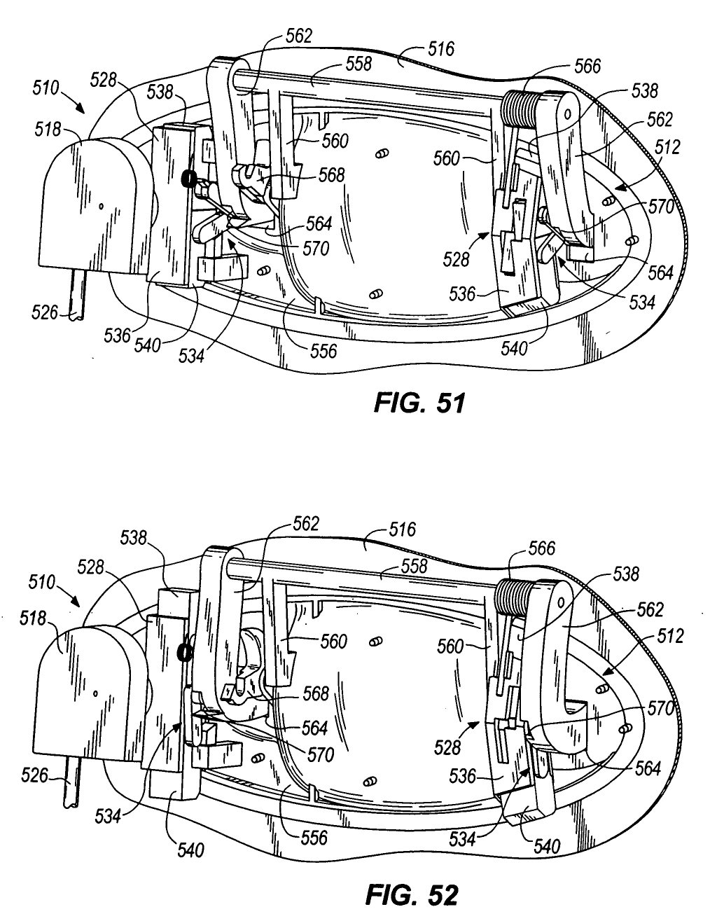

The outside door handle assembly 512 includes a securing assembly 528 (FIGS. 51-52) similar to the securing assembly 528 of the outside interface member 510. The securing assembly 528 includes a securing linkage 534. The securing linkage 534 includes a block guide 536 that slidably retains upper and lower securing blocks 538, 540. The securing linkage 534 also includes an upper linkage 542 pivotally coupled to a lower linkage 544 at their first ends. The opposite end of the upper linkage 542 is pivotally coupled to the upper block 538 and the opposite end of the lower linkage 544 is pivotally coupled to the lower block 540. The upper linkage 542 includes a boss 546 adjacent the first end of the upper linkage 542 and extending in a direction opposite to the block guide 536. The boss 546 is received within a slot 570 in the nearest support arm 562. The upper securing block 538 can be extended upwardly and the lower securing block 540 can be extended downwardly by moving the securing linkage 534 in a first, or securing direction toward the interior of the door 516. In this embodiment, assembly of the outside door handle assembly 512 begins with the securing linkage 534 in the unsecured position with the securing blocks 538, 540 retracted within the block guide 536.

The assembly of the outside door handle assembly 512 is illustrated in FIGS. 51-52. The outside door handle assembly 512 is inserted into the main opening 552 of the door 516 from the outside of the door 516 with the outside door handle 554 in the actuated position. The boss 546 of the securing linkage 534 is received within a slot 570 on the second support arm 562 nearest the outside interface member 510. In FIG. 52, the outside door handle 554 is moved to the deactuated position thereby extending the upper and lower securing blocks 538, 540 outwardly from the block guides 536 such that the exposed ends of the securing blocks 538, 540 contact the interior sides of the outer skin of the door 516 around the main opening 552. Specifically, as the outside door handle 554 moves from the actuated position, the bosses 546 reach the end of their respective slots 570. Continued motion of the outside door handle 554 moves the bosses 546 toward the secured position causing the upper and lower linkages 542, 544 to move the upper and lower securing blocks 538, 540, respectively. Although not illustrated in the drawings, when the outside door handle 554 is moved to the actuated position, the bosses 546 exit the slots 570 such that the bosses 546 are not moved back into the unsecured position. By this arrangement, further actuation and deactuation of the outside door handle 554 does not move the securing blocks 538, 540 from the secured, extended position.

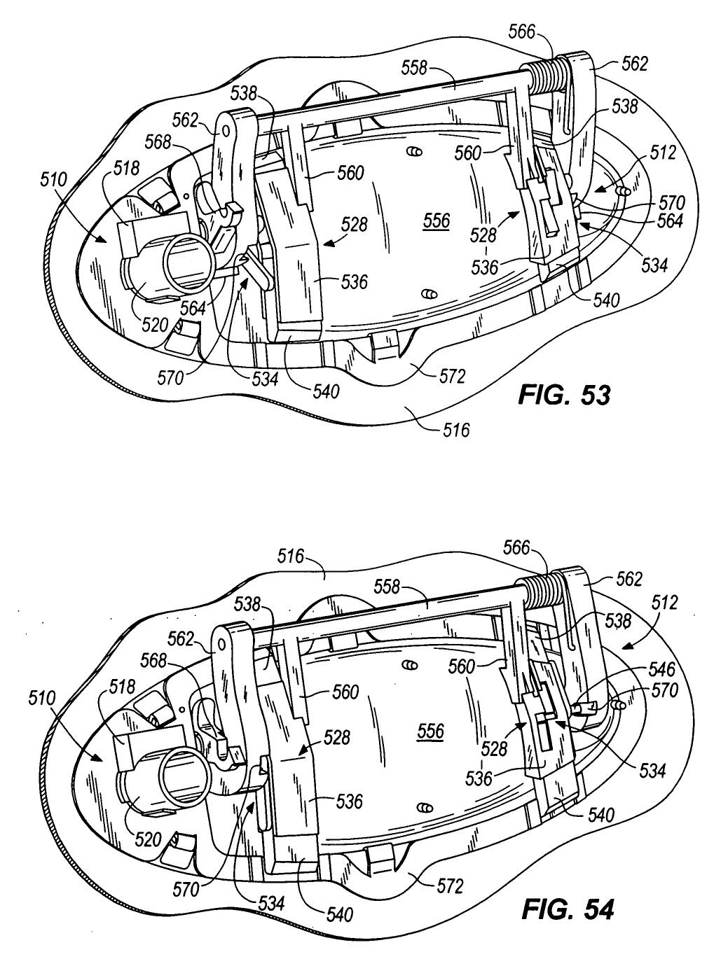

Another embodiment of the outside interface member 510 and the outside door handle assembly 512 is illustrated in FIGS. 53-55. This embodiment is similar to the previously-described embodiment (FIGS. 46-52) except that in this embodiment, the securing assembly 528 on the outside interface member 510 is moved to the adjacent side of the outside door handle assembly 512 such that both of the securing assemblies 528 are located on the outside door handle assembly 512. Another difference is that the outside interface member 510 includes an interior bezel 572 that encircles the main opening 552 of the outer skin of the door 516. The interior bezel 572 is sandwiched between the extended securing blocks 538, 540 and the outer skin of the door 516 to secure the outside interface member 510 to the door 516.

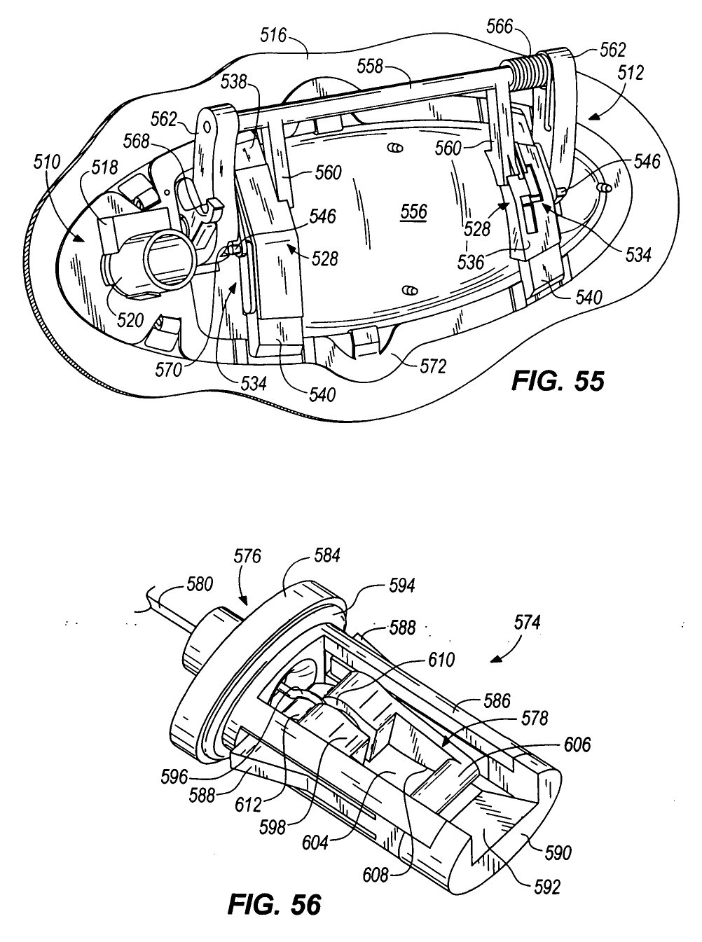

The assembly of the outside door handle assembly 512 is illustrated in FIGS. 53-55. The outside door handle assembly 512 is inserted into the main opening 552 of the door 516 from the outside of the door 516 with the outside door handle 554 in the actuated position. The bosses 546 of the securing linkages 534 are received within slot 570 on the support arms 562. In FIG. 54, the outside door handle 554 is moved to the deactuated position thereby extending the upper and lower securing blocks 538, 540 outwardly from the block guides 536 such that the exposed ends of the securing blocks 538, 540 contact the interior sides of the bezel 572 adjacent the outer skin of the door 516 around the main opening 552. Specifically, as the outside door handle 554 moves from the actuated position, the bosses 546 reach the end of their respective slots 570. Continued motion of the outside door handle 554 moves the bosses 546 toward the secured position causing the upper and lower linkages 542, 544 to move the upper and lower securing blocks 538, 540, respectively. As illustrated in FIG. 55, when the outside door handle 554 is moved to the actuated position, the bosses 546 exit the slots 570 such that the bosses 546 are not moved back into the unsecured position. By this arrangement, further actuation and deactuation of the outside door handle 554 does not move the securing blocks 538, 540 from the secured, extended position.

FIGS. 56-59 illustrate another embodiment of an inside interface member 574. The inside interface member 574 includes a housing 576 that supports a linkage 578. The linkage 578 is coupled to the inside door release cable 580 and the inside door handle assembly 582 such that actuation of the inside door handle assembly 582 actuates the linkage 578 to pull the inside door release cable 580 and unlatch the door latch. The housing 576 includes a mounting flange 584 and a cage 586 coupled to the mounting flange 584. The cage 586 includes two mounting tabs 588 that are each positioned on opposite sides of the cage 586. An end member 590 is coupled to the end of the cage 586 and defines a ramp portion 592. The cage 586 is inserted into an aperture (not shown) in the door 516 such that the linkage 598 is at least partially exposed on the interior side of the door 516. Specifically, the cage 586 is inserted through the aperture until the mounting tabs 588 lock against the door 516 and the mounting flange 584 is in contact with the door 516. After the inside interface member 574 is assembled to the door 516, the door 516 is sandwiched between the mounting tabs 588 and the mounting flange 584. An 0-ring 594 can be positioned between the door 516 and the mounting flange 584 to create a seal.

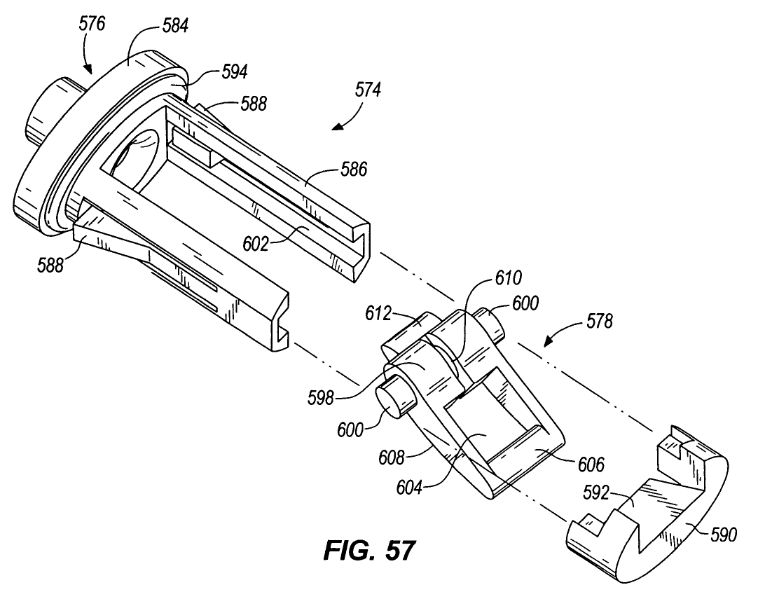

The linkage 578 includes a spring 596 coupled to the inside door release cable 580 and an interface tab 598 coupled to the spring 596. With reference to FIG. 57, the interface tab 598 includes side bosses 600 that are received within interior slots 602 of the cage 586 to slidably and pivotally couple the linkage 578 to the cage 586. The interface tab 598 also includes an aperture 604 and an engagement portion 606 at one end of the aperture 604. The bottom portion of the interface tab 598 defines a cam surface 608. The spring 596 is coupled to the interface tab 598 through a slot 610 on one side of the interface tab 598, which includes a spring stop 612 that intermittently contacts the spring 596 to bias the interface tab 598 in a desired orientation.

The assembly of the inside door handle assembly 582 to the inside interface member 574 is illustrated in FIGS. 58A-58E. The inside door handle assembly 582 includes a post 614 having a notch 616 located near the distal end of the post 614. In FIG. 58A, the inside interface member 574 is illustrated in its assembled position and the inside door handle assembly 582 is illustrated on the interior side of the door 516 moving toward the assembled position (i.e., closer to the inside interface member 574). As the inside door handle assembly 582 moves closer to the assembled position, the distal end of the post 614 contacts the engagement portion 606 of the interface tab 598 (FIG. 58B). The contact pushes the interface tab 598 away from the inside door handle assembly 582 against the bias of the spring 596. When the inside door handle assembly 582 continues to move toward the assembled position, the post 614 moves off of the engagement portion 606 and moves into the aperture 604 allowing the interface tab 598 to return to its biased position (FIG. 58C). The spacing between the post 614 and the notch 616 is exaggerated in FIG. 58C for clarity. The inside door handle assembly 582 is fixed to the inside of the door 516 in this position. The biased interface tab 598 facilitates the assembly of the inside door handle assembly 582 by allowing compensation for any misalignment caused by the blind assembly inherent when moving the inside door handle assembly 582 into the assembled position which at least partially covers the interface tab 598. Also, the biased interface tab 598 compensates for any misalignment caused by any partial actuation of the inside door handle assembly 582 by the assembler during the assembly process.

Actuation of the inside door handle (not shown) moves the post 614 to the right as viewed in FIG. 58D. The tip of the post 614 contacts the engagement portion 606 thereby moving the interface tab 598 to the right. As the post 614 and engagement portion 606 continue the movement to the right, the cam surface 608 contacts the ramp portion 592 causing the interface tab 598 to pivot away from the ramp 592. By this action, the engagement portion 606 is moved relative to the post 614 causing the engagement portion 606 to be received within the notch 616. Also, as the interface tab 598 moves to the extreme right position illustrated in FIG. 58E, the door latch is released. When the inside door handle is allowed to return to the deactuated position, the engagement portion 606 remains within the notch 616.

An additional embodiment of the inside interface member 574 is illustrated in FIG. 59. This embodiment is similar to the embodiment illustrated in FIGS. 56-58, except that the embodiment of FIG. 59 includes a leaf spring 618 to bias the interface tab 598 in a desired orientation allowing the engagement portion 606 to be received by the notch 616 as described above.

Although exemplary embodiments of the present invention have been shown and described with reference to particular embodiments and applications thereof, it will be apparent to those having ordinary skill in the art that a number of changes, modifications, or alterations to the invention as described herein may be made, none of which depart from the spirit or scope of the present invention. All such changes, modifications, and alterations should therefore be seen as being within the scope of the present invention.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiments described herein are further intended to explain best modes known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

We claim:

1. A door latch assembly for installation on a door of a vehicle, the door having an inner panel, an outer panel, and a cavity defined between at least portions of the inner and outer panels, the inner panel having an interior side, the door latch assembly comprising:
a latch securable to the door at least partially within the cavity and actuatable between a plurality of states;
a linkage coupled to the inner panel, the linkage being operably coupled to the latch and accessible from the interior side; and
a user manipulatable control coupled to the linkage by insertion of the user manipulatable control into the inner panel from the interior side of the inner panel, the user manipulatable control being operable to selectively actuate the latch through the linkage between the plurality of states.

2. The door latch assembly of claim 1, wherein the door includes a trim panel coupled to the interior side of the inner panel, the trim panel having an interior side opposite to the inner panel and an aperture, wherein the linkage is securable to the door such that the linkage is accessible from the interior side of the trim panel through the aperture, and wherein the user manipulatable control is at least partially insertable through the aperture from the interior side of the trim panel to couple to the linkage.

3. The door latch assembly of claim 1, wherein the user manipulatable control includes an inside door handle, and wherein the plurality of states includes an open state and a closed state.

4. The door latch assembly of claim 3, further comprising a cable connected between the linkage and the latch, wherein the inside door handle includes a projection, and wherein the linkage includes a cable actuator coupled between the cable and the projection, the inside door handle being operable to actuate the latch through the projection, cable actuator, and cable between open and closed states.

5. The door latch assembly of claim 3, wherein the inside door handle is a self-docking type inside door handle.

6. The door latch assembly of claim 1, further comprising a housing coupled to the linkage and the door, wherein the linkage is coupled to the inner panel through the housing.

7. The door latch assembly of claim 6, wherein the housing includes a mounting flange fastened to the inner panel.

8. The door latch assembly of claim 1, further comprising a cable connected between the linkage and the latch, the user manipulatable control being operable to selectively actuate the latch through the linkage and cable.

9. A method of installing a door latch assembly to a door of a vehicle, the method comprising:
providing a latch that is actuatable between a plurality of states;
operably coupling a linkage to the latch;
securing the latch to the door within a cavity of the door defined at least partially by inner and outer panels;
securing the linkage to the inner panel such that the linkage is accessible from an interior side of the inner panel;
coupling the user manipulatable control to the linkage from the interior side; and
operating the user manipulatable control to selectively actuate the latch through the linkage between the plurality of states.

10. The method claim 9, wherein:
securing the linkage includes securing the linkage to the inner panel such that the linkage is accessible from an interior side of a trim panel coupled to the inner panel through an aperture in the trim panel; and
the method further comprises inserting a user manipulatable control at least partially through the aperture from the interior side of the trim panel.

11. The method of claim 9, wherein coupling the user manipulatable control includes coupling an inside door handle to the linkage from the interior side, and wherein operating the user manipulatable control includes operating the inside door handle to selectively actuate the latch through the linkage between open and closed states.

12. The method of claim 11, wherein:
operably coupling a linkage to the latch includes operably coupling the linkage to the latch with a cable;
coupling the inside door handle to the linkage includes coupling a projection of the inside door handle to a cable actuator of the linkage; and
operating the inside door handle includes operating the inside door handle to selectively actuate the latch through the projection, cable actuator, and cable between the open and closed states.

13. The method of claim 11, further comprising docking the inside door handle to the inner panel by insertion of the inside door handle within the aperture.

14. The method of claim 9, wherein securing the linkage to the inner panel includes securing the linkage to the inner panel through a housing such that the linkage is accessible from the interior side of the inner panel.

15. The method of claim 14, wherein securing the linkage to the inner panel through the housing includes fastening a mounting flange of the housing to the inner panel.

16. The method of claim 9, wherein operably coupling a linkage to the latch includes operably coupling the linkage to the latch with a cable.

17. A door latch assembly for installation on a door of a vehicle, the door having a frame and a trim panel coupled to the frame, the trim panel having an exterior side, an interior side, and an aperture in communication between the exterior and interior sides, the door latch assembly comprising:
a latch securable to the door and located on the exterior side of the trim panel, the latch being actuatable between open and closed states; and
a self-docking inside door handle assembly at least partially insertable within the aperture from the interior side to couple to the frame through the aperture without the use of fasteners and to operably couple to the latch, the inside door handle assembly being operable to selectively actuate the latch between the open and closed states.

18. The door latch assembly of claim 17, further comprising a linkage securable to the frame on the external side, the linkage being operably coupled to the latch and accessible from the interior side through the aperture, wherein the inside door handle assembly couples with the linkage when the inside door handle assembly is at least partially inserted into the door, and wherein the inside door handle assembly operates to selectively actuate the latch through the linkage between open and closed states.

19. The door latch assembly of claim 18, further comprising a cable connected between the linkage and the latch, wherein the inside door handle assembly includes a projection, and wherein the linkage includes a cable actuator coupled between the cable and the projection, the inside door handle assembly being operable to actuate the latch through the projection, cable actuator, and cable between the open and closed states.

20. The door latch assembly of claim 18, further comprising a housing coupled to the linkage and the door, wherein the linkage is coupled to the door through the housing.

21. The door latch assembly of claim 20, wherein the housing includes a mounting flange fastened to the frame on the exterior side.

22. The door latch assembly of claim 18, further comprising a cable connected between the linkage and the latch, the inside door handle assembly being operable to selectively actuate the latch through the linkage and cable between the open and closed states.

23. The door latch assembly of claim 17, wherein the inside door handle assembly includes a clip adapted to secure the inside door handle assembly with respect to the door when the inside door handle assembly is at least partially inserted into the aperture from the interior side.

24. The door latch assembly of claim 17, wherein the inside door handle assembly includes a housing and an inside door handle pivotally coupled to the housing, the housing being sized to be press-fit into the aperture and to remain secured within the aperture when the inside door handle is operated to selectively actuate the latch between the open and closed states.

25. The door latch assembly of claim 17, wherein the trim panel defines a plane, and wherein the inside door handle assembly is coupled to the door by moving the inside door handle assembly substantially perpendicular to the plane.

26. A method of installing a door latch assembly to a door of a vehicle, the method comprising:
providing a latch that is actuatable between open and closed states;
securing the latch on an exterior side of a trim panel of the door coupled to the frame;
at least partially inserting a self-docking inside door handle assembly through an aperture in the trim panel from an interior side of the trim panel;
coupling the inside door handle assembly to the door by at least partially inserting the inside door handle through the aperture;
operably coupling the inside door handle assembly to the latch; and
operating the inside door handle assembly to selectively actuate the latch between the open and closed states.

27. The method of claim 26, further comprising:
operably coupling a linkage to the latch;
securing the linkage to the frame on the external side such that the linkage is accessible from the interior side through the aperture, wherein operably coupling the inside door handle assembly includes coupling the inside door handle assembly to the linkage, and wherein operating the inside door handle assembly includes operating the inside door handle assembly to selectively actuate the latch through the linkage between the open and closed states.

28. The method of claim 27, wherein:
operably coupling a linkage to the latch includes operably coupling the linkage to the latch with a cable;
coupling the inside door handle assembly to the linkage includes coupling a projection of the inside door handle to a cable actuator of the linkage; and
operating the inside door handle assembly includes operating the inside door handle assembly to selectively actuate the latch through the projection, cable actuator, and cable between the open and closed states.

29. The method of claim 27, wherein securing the linkage to the frame includes securing the linkage to the frame through a housing such that the linkage is accessible from the interior side through the aperture.

30. The method of claim 29, wherein securing the linkage to the door through the housing includes fastening a mounting flange of the housing to the frame.

31. The method of claim 27, wherein operably coupling a linkage to the latch includes operably coupling the linkage to the latch with a cable, and wherein operating the inside door handle assembly includes operating the inside door handle assembly to selectively actuate the latch through the linkage and cable between the open and closed states.

32. The method of claim 26, wherein coupling the inside door handle assembly to the frame through the aperture without the use of fasteners includes connecting a clip of the inside door handle assembly to the frame.

33. The method of claim 26, wherein coupling the inside door handle assembly to the frame through the aperture without the use of fasteners includes press-fitting a housing of the inside door handle assembly into the aperture, the method further comprising retaining the inside door handle assembly within the aperture with the housing when the inside door handle is operated to selectively actuate the latch between the open and closed states.

34. The method of claim 26, wherein coupling the inside door handle assembly to the frame through the aperture without the use of fasteners includes moving the inside door handle assembly perpendicular to a plane defined by the trim panel.

35. A door latch assembly for installation on a door of a vehicle, the door having an outer panel with an interior side and an exterior side, the door latch assembly comprising:
a latch securable to the door, located on the interior side of the outer panel, and actuatable between a plurality of states; and
a linkage operably coupled to the latch;
a bracket coupled between the latch and the linkage, the bracket being sufficiently resilient to retain the linkage in a position relative to the latch.

36. The door latch assembly of claim 35, wherein the door includes an aperture communicating between the interior and exterior sides, wherein the linkage is positioned by the bracket to be accessible from the exterior side through the aperture.

37. The door latch assembly of claim 36, further comprising a user manipulatable control insertable at least partially through the aperture from the exterior side to couple to the linkage, the user manipulatable control being operable to selectively actuate the latch through the linkage between the plurality of states.

38. The door latch assembly of claim 37, wherein the user manipulatable control includes an outside door handle, and wherein the plurality of states includes an open state and a closed state.

39. The door latch assembly of claim 37, wherein the user manipulatable control includes an outside door lock, and wherein the plurality of states includes a locked state and an unlocked state.

40. The door latch assembly of claim 37, wherein the user manipulatable control includes an outside door handle and an outside door lock, and wherein the plurality of states includes an open state, a closed state, a locked state, and an unlocked state.

41. The door latch assembly of claim 35, wherein the door includes an aperture, and wherein the linkage is positioned by the bracket to at least partially extend through the aperture.

42. The door assembly of claim 35, wherein the linkage includes a sill button, and wherein the plurality of states includes a locked and an unlocked state.

43. The door latch assembly of claim 35, wherein the bracket is flexible.

44. The door latch assembly of claim 35, wherein the bracket comprises at least one of rubber and resiliently deformable plastic.

45. The door latch assembly of claim 35, wherein the linkage is operably coupled to the latch by a cable.

46. The door latch assembly of claim 35, wherein the linkage is coupled to the door in substantially the same position as the position relative to the latch when the latch is secured to the door.

47. A method for installing a door latch assembly on a door of a vehicle, the method comprising:
providing a latch that is securable to the door on an interior side of the door and actuatable between a plurality of states;
operably coupling a linkage to the latch;
coupling a resilient bracket between the latch and the linkage;
securing the latch to the door;
retaining the linkage in a position relative to the latch with the bracket.

48. The method of claim 47, wherein retaining the linkage includes positioning the linkage such that the linkage is accessible from the exterior side through an aperture in the door.

49. The method of claim 48, further comprising at least partially inserting a user manipulatable control through the aperture from the exterior side to couple to the linkage, and operating the user manipulatable control to selectively actuate the latch through the linkage between the plurality of states.

50. The method of claim 49, wherein at least partially inserting a user manipulatable control includes at least partially inserting an outside door handle, and wherein operating the user manipulatable control includes operating the outside door handle to selectively actuate the latch through the linkage between open and closed states.

51. The method of claim 49, wherein at least partially inserting a user manipulatable control includes at least partially inserting an outside door lock, and wherein operating the user manipulatable control includes operating the outside door lock to selectively actuate the latch through the linkage between locked and unlocked states.

52. The method of claim 51, wherein at least partially inserting a user manipulatable control includes at least partially inserting an outside door handle, and wherein operating the user manipulatable control includes operating the outside door handle and outside door lock to selectively actuate the latch through the linkage between open, closed, locked, and unlocked states.

53. The method of claim 47, further comprising positioning the linkage such that the linkage at least partially extends through an aperture in the door.

54. The method of claim 53, wherein positioning the linkage includes positioning a sill button such that the sill button extends through the aperture.

55. The method of claim 47, wherein operably coupling a linkage to the latch includes operably coupling the linkage to the latch with a cable.

56. The method of claim 47, further comprising coupling the linkage to the door in substantially the same position as the position relative to the latch.

57. A door latch assembly for installation on a door of a vehicle, the door having an outer panel with an interior side and an exterior side, the door latch assembly comprising:
a latch securable to the door and located on the interior side of the outer panel and actuatable between a plurality of states;
a user manipulatable control securable to the door;
a linkage operably coupled between the latch and the user manipulatable control; and
a shield at least partially covering the linkage along a length of the linkage between the user manipulatable control and the latch to at least partially restrict access to the linkage.

58. The door latch assembly of claim 57, wherein the user manipulatable control includes an outside door handle, and wherein the plurality of states includes an open state and a closed state.

59. The door latch assembly of claim 57, wherein the user manipulatable control includes an outside door lock, and wherein the plurality of states includes a locked state and an unlocked state.

60. The door latch assembly of claim 57, wherein the user manipulatable control includes an outside door handle and an outside door lock, and wherein the plurality of states includes an open state, a closed state, a locked state, and an unlocked state.

61. The door latch assembly of claim 57, wherein the user manipulatable control includes an inside door lock, and wherein the plurality of states includes a locked state and an unlocked state.

62. The door latch assembly of claim 61, wherein the inside door lock is a sill button.

63. The door latch assembly of claim 57, wherein the shield member is flexible.

64. The door latch assembly of claim 57, wherein the shield member comprises at least one of rubber and resiliently deformable plastic.

65. The door latch assembly of claim 57, wherein the linkage includes a cable.

66. The door latch assembly of claim 57, wherein the shield member substantially covers all sides of the linkage along the length of the linkage.

67. The door latch assembly of claim 57, wherein the shield member encapsulates the linkage between the latch and the user manipulatable control.

68. A door latch assembly for installation on a door of a vehicle, the door having an outer panel with an interior side, an exterior side, and an aperture communicating between the interior and exterior sides, the door latch assembly comprising:
a housing accessible from the exterior side through the aperture; and
an outside door lock at least partially received within the housing through the aperture from the exterior side, the outside door lock having a flange portion, and first and second states, the outside door lock being freely removable from the housing in the first state and the outside door lock being resistant to removal from the housing in the second state, a portion of the door surrounding the aperture being coupled between the flange and the housing when the outside door lock is in the second state.

69. The door latch assembly of claim 68, further comprising a latch securable to the door on the interior side and actuatable between locked and unlocked states, wherein:
the housing includes a linkage operably coupled to the latch;
the outside door lock couples to the linkage when the outside door lock is at least partially received within the housing; and
the outside door lock is operable to selectively actuate the latch through the linkage between the locked and unlocked states.

70. The door latch assembly of claim 69, wherein the outside door lock is operable to selectively actuate the latch by turning a key inserted into the outside door lock.

71. The door latch assembly of claim 69, wherein the outside door lock includes a central axis and an extension positioned a distance away from and rotatable about the central axis, the extension being engagable with the linkage.

72. The door latch assembly of claim 71, further comprising a cable connected between the linkage and the latch, wherein the linkage includes a cable actuator coupled between the extension and the cable such that the outside door lock is operable to actuate the latch through the extension, cable actuator, and cable between the locked and unlocked states.

73. The door latch assembly of claim 68, wherein the housing includes a cylindrical opening, and wherein the outside door lock is received within the cylindrical opening of the housing.

74. The door latch assembly of claim 68, wherein the outside door lock includes a projection, the projection being retracted in the first state to retain the outside door lock in the housing and extended in the second state in which the outside door lock is insertable in the housing.

75. The door latch assembly of claim 74, wherein the projection is biased toward an extended state with respect to the housing.

76. A method for assembling a door latch assembly on a door of a vehicle, the method comprising:
providing an outside door lock having a flange portion, and first and second states;
positioning a lock housing on an interior side of the door such that the lock housing is accessible from an exterior side of the door through an aperture defined in the door;
at least partially inserting the outside door lock within the housing through the aperture from the exterior side of the door while the outside door lock is in the first state,
coupling a portion of the door defining the aperture between the flange portion and the housing;
changing the outside door lock from the first state to the second state after the outside door lock is at least partially inserted into the housing; and
resisting removal of the outside door lock from the housing while the outside door lock is in the second state.

77. The method of claim 76, further comprising:
providing a latch actuatable between locked and unlocked states;
securing the latch to the door on the interior side;
coupling a linkage to the housing;
operably coupling the linkage to the latch;
coupling the outside door lock to the linkage when the outside door lock is at least partially received within the housing; and
operating the outside door lock to selectively actuate the latch through the linkage between the locked and unlocked states.

78. The method of claim 77, wherein operating the outside door lock includes turning a key inserted into the outside door lock.

79. The method of claim 77, wherein providing an outside door lock includes providing an outside door lock having a central axis and a pin positioned a distance away from and rotatable about the central axis, and wherein the method further comprises coupling the pin to the linkage by at least partially inserting the outside door lock within the housing.

80. The method of claim 79, wherein operatively coupling the linkage to the latch includes operatively coupling a cable actuator of the linkage to the latch with a cable, and wherein operating the outside door lock includes operating the outside door lock to selectively actuate the latch through the pin, cable actuator, and cable between the locked and unlocked states.

81. The method of claim 76, wherein:
at least partially inserting the outside door lock includes at least partially inserting the outside door lock within a cylindrical opening of the housing through the aperture from the exterior side while the outside door lock is in the first state;
changing the outside door lock includes changing the outside door lock from the first state to the second state after the outside door lock is at least partially inserted into the cylindrical opening; and
resisting removal of the outside door lock includes resisting removal of the outside door lock from the cylindrical opening while the outside door lock is in the second state.

82. The method of claim 76, wherein:
providing an outside door lock includes providing an outside door lock having a projection that is retracted in the first state and extended in the second state;
at least partially inserting the outside door lock includes at least partially inserting the outside door lock within the housing through the aperture from the exterior side while the projection is retracted;
changing the outside door lock includes extending the projection after the outside door lock is at least partially inserted into the housing; and
resisting removal of the outside door lock includes resisting removal of the outside door lock from the housing while the projection is extended.

83. The method of claim 82, further comprising biasing the projection toward the extended state.

84. A door latch assembly for installation on the door of a vehicle, the door latch assembly comprising:
a latch having at least one projection;
a slot along which the latch is movable with respect to the door, the slot dimensioned to slidably receive the at least one projection, the latch movable between a first state where the at least one projection is located at a first location along the slot, and a second state where the at least one projection is located in a second location spaced apart from the first location along the slot, the latch being securable to the door in the second state.

85. The door latch assembly of claim 84, wherein the slot is formed by a channel coupled to the door.

86. The door latch assembly of claim 84, wherein the at least one projection is a pin.

87. The door latch assembly of claim 86, wherein the pin includes an enlarged head and a shaft portion extending between the latch and the enlarged head, the shaft portion extending through the at least one slot, and the enlarged head being positioned on a side of the at least one slot opposite the latch.

88. The door latch assembly of claim 84, further comprising a carrier panel securable to the door, wherein the slot is located on the carrier panel.

89. The door latch assembly of claim 88, wherein the slot includes a first end and an opposite second end, the first end being open to receive the at least one projection, wherein the latch is maintained within the slot by a stop on the carrier.

90. The door latch assembly of claim 89, wherein the stop is a cradle that supports the latch in the first state.

91. The door latch assembly of claim 84, further comprising a linkage operably coupled to the latch, wherein the door includes an external side, an internal side, and an aperture communicating between the internal and external sides, the linkage being accessible through the aperture from the external side when the latch is in the second state.

92. The door latch assembly of claim 91, further comprising a user manipulatable control insertable through the aperture from the external side to couple with the linkage when the latch is in the second state.

93. The door latch assembly of claim 92, wherein the user manipulatable control is an outside door handle.

94. The door latch assembly of claim 92, wherein the user manipulatable control is an outside door lock.

95. The door latch assembly of claim 84, further comprising an inside door lock operably coupled to the latch, wherein the door includes an aperture, the inside door lock extending through the aperture when the latch is moved to the second state.

96. The door latch assembly of claim 95, wherein the inside door lock includes a sill button.

97. The door latch assembly of claim 84, wherein:
the at least one projection includes a first projection and a second projection;
the slot is a first slot, and
the door latch assembly includes a second slot;
the latch is movable between the first state in which the first projection is located along the first slot in the first location and the second projection is located along the second slot in a first location of the second slot, and the second state where the first projection is located along the first slot in the second location spaced apart from the first location of the first slot and the second projection is located along the second slot at a second location spaced apart from the first location of the second slot.

98. The door latch assembly of claim 97, wherein the orientation of the latch is fixed by the first and second projections and the first and second slots at the second locations.

99. The door latch assembly of claim 98, wherein the orientation of the latch is dependent upon the position of the latch between the first and second states.

100. A method for installing a door latch assembly on the door of a vehicle, the method comprising:
providing a latch having at least one projection;
receiving the at least one projection within a slot extending a length along the door;
moving the latch between a first state in which the at least one projection is located at a first location along the slot, and a second state in which the at least one projection is located in a second location spaced apart from the first location along the slot; and
securing the latch to the door in the second state.

101. The method of claim 100, wherein:
providing a slot includes providing a channel having a length;
receiving the at least one projection within the slot includes receiving the at least one projection within the channel; and
moving the latch includes moving the latch between a first state in which the at least one projection is located at a first location along the channel, and a second state in which the at least one projection is located in a second location along the channel spaced apart from the first location along the channel.

102. The method of claim 100, wherein providing a latch having at least one projection includes providing a latch with a pin, wherein receiving the at least one projection includes receiving the pin within the slot, and wherein moving the latch includes moving the latch between a first state in which the pin is located at a first location along the slot, and a second state in which the pin is located in a second location spaced apart from the first location along the slot.

103. The method of claim 102, wherein receiving the pin within the slot includes extending a shaft portion of the pin through the slot, and positioning an enlarged head on a side of the slot opposite the latch.

104. The method of claim 100, further comprising:
providing a carrier panel on which the slot is defined; and
securing the carrier panel to the door.

105. The method of claim 104, further comprising:
mounting a stop to the carrier panel; and
maintaining the latch within the slot by the stop.

106. The method of claim 105, wherein mounting a stop includes mounting a cradle to the carrier panel, the method further comprising supporting the latch in the first state with the cradle, and wherein maintaining the latch includes maintaining the latch within the slot by the cradle.

107. The method of claim 100, further comprising operably coupling a linkage to the latch, wherein moving the latch includes moving the latch to the second state in which the linkage is accessible through an aperture of the door from an external side of the door.

108. The method of claim 107, further comprising:
at least partially inserting a user manipulatable control through the aperture from the external side;
coupling the user manipulatable control to the linkage from the external side when the latch is in the second state; and
operating the user manipulatable control to actuate the latch through the linkage.

109. The method of claim 108, wherein:
at least partially inserting a user manipulatable control includes at least partially inserting an outside door handle through the aperture from the external side;
coupling the user manipulatable control includes coupling the outside door handle to the linkage from the external side when the latch is in the second state; and
operating the user manipulatable control includes operating the outside door handle to actuate the latch through the linkage between open and closed states.

110. The method of claim 109, wherein:
at least partially inserting a user manipulatable control includes at least partially inserting a outside door lock through the aperture from the external side;
coupling the user manipulatable control includes coupling the outside door lock to the linkage from the external side when the latch is in the second state; and
operating the user manipulatable control includes operating the outside door lock to actuate the latch through the linkage between locked and unlocked states.

111. The method of claim 100, further comprising operably coupling an inside door lock to the latch, wherein moving the latch includes extending the inside door lock through an aperture of the door when the latch is moved to the second state.

112. The method of claim 111, wherein operably coupling an inside door lock includes operably coupling a sill button to the latch, and wherein extending the inside door lock includes extending the sill button through the aperture when the latch is moved to the second state.

113. The method of claim 100, wherein:
providing a latch having at least one projection includes providing a latch having first and second projections;
providing a slot includes providing first and second slots;
receiving the at least one projection within the slot includes receiving the first projection within the first slot and receiving the second projection within the second slot; and
moving the latch includes moving the latch between the first state where the first projection is located along the first slot in the first location of the first slot and the second projection is located along the second slot in a first location of the second slot, and a second state where the first projection is located along the first slot in a second location spaced apart from the first location of the first slot and the second projection is located along the second slot at a second location spaced apart from the first location of the second slot.

114. The method of claim 113, further comprising fixing the orientation of the latch at the second location with the first and second projections and the first and second slots.

115. The method of claim 114, further comprising fixing the orientation of the latch in states between the first and second states.
